(19) United States
(12) Patent Application Publication
(10) Pub. No.: US 2024/0209124 A1
(43) Pub. Date: Jun. 27, 2024

(54) PROCESSES FOR TRANSITIONING BETWEEN DIFFERENT POLYMERIZATION CATALYSTS IN A POLYMERIZATION REACTOR

(71) Applicant: ExxonMobil Chemical Patents Inc., Baytown, TX (US)

(72) Inventors: Diwaker SINGH, Singapore (SG); Richard B. PANNELL, Liberty, TX (US); Timothy M. BOLLER, Houston, TX (US); Gerardo CORONA, Friendswood, TX (US); Fred D. EHRMAN, Houston, TX (US); Charles J. HARLAN, Houston, TX (US); Yan JIANG, Houston, TX (US); Chi-l KUO, Atascocita, TX (US); William A. LAMBERTI, Stewartsville, NJ (US); Sateesh K. RAJPUT, Sarnia (CA); Shayan KARIMIPOUR, Katy, TX (US)

(21) Appl. No.: 18/557,110

(22) PCT Filed: Apr. 25, 2022
(86) PCT No.: PCT/US2022/071891

§ 371 Date: Oct. 25, 2023

Related U.S. Application Data
(60) Provisional application No. 63/182,272, filed on Apr. 30, 2021.

(51) Int. Cl. C08F 2/34

(52) U.S. Cl. CPC C08F 2/34; C08F 2410/02; C08F 2410/05; C08F 2410/08

(57) ABSTRACT

Processes for transitioning from a first catalyst to a second catalyst in a gas phase polymerization reactor. In some embodiments, the processes relate to transitioning from a metallocene catalyst to a Ziegler-Natta catalyst. In other embodiments, the processes relate to transitioning from a first Ziegler-Natta catalyst to a second Ziegler-Natta catalyst.

### CROSS-REFERENCE TO RELATED APPLICATION

This application claims the benefit of U.S. Provisional Application No. 63/182,272 filed Apr. 30, 2021 entitled “Processes for Transitioning Between Different Polymerization Catalysts in a Polymerization Reactor”, the entirety of which is incorporated by reference herein.

### FIELD

This disclosure relates to processes for transitioning between different polymerization catalysts in a polymerization reactor. More particularly, this disclosure relates to processes for transitioning from a metallocene catalyst to a Ziegler-Natta catalyst and for transitioning from a first Ziegler-Natta catalyst to a second Ziegler-Natta catalyst.

### BACKGROUND

Gas-phase polymerization is useful for polymerizing ethylene or ethylene and one or more co-monomers. Polymerization processes in fluidized beds are particularly economical. During polymerization it can be necessary to transition from a first catalyst to a second catalyst. Such catalyst transitions can arise when it is desired to produce a different polymer product that requires a different catalyst.

Transitioning between different catalysts, e.g., a metallocene catalyst to a Ziegler-Natta catalyst or between different Ziegler-Natta catalyst grades, has been problematic due to high skin temperatures within the polymerization reactor during start-up that cause moderate to severe sheeting that often requires the reactor be shut down, opened for maintenance, and then another restart of the reactor.

There is a need, therefore, for improved processes for transitioning between different polymerization catalysts in a polymerization reactor. This disclosure satisfies this and other needs.

References of potential interest in this and related areas include: U.S. Pat. Nos. 5,627,242; 6,384,157; 6,995,217; 8,039,562; 8,729,199; 8,742,041; 8,957,167; 9,475,892; 10,329,364; and 10,494,454; US patent publications 2013/0046070, and 2018/0051102; as well as Sirohi & Choi, On-Line Parameter Estimation in a Continuous Polymerization Process, IND. ENG. CHEM. RES. 35, 1332-1343 (1996).

### SUMMARY

Processes for transitioning between different polymerization catalysts in a gas phase polymerization reactor are provided. In some embodiments, a process for transitioning from a metallocene catalyst to a Ziegler-Natta catalyst in a gas phase polymerization reactor can include introducing a first olefin, an anti-static agent, a first carrier gas, and a plurality of metallocene catalyst particles into the reactor under conditions effective to maintain the metallocene catalyst particles in a fluidized state and to polymerize the first olefin in the presence of the metallocene catalyst particles to produce a first polymer product. Introduction of the metallocene catalyst particles and the anti-static agent into the reactor can be stopped. A kill agent can be introduced into the reactor to stop polymerization of the first olefin within the reactor. Introduction of the first olefin into the reactor can be stopped. A first portion of the first olefin can be removed from the reactor. The first polymer product, the metallocene catalyst particles, and the anti-static agent can be removed from the reactor. A second portion of the first olefin within the reactor can be removed such that the reactor contains ≤1,000 ppmv (volume ppm, on basis of volume of the vessel in question, in this case the reactor) of the first olefin. A first aluminum-containing compound can be introduced into the reactor after the concentration of the first olefin is reduced to ≤1,000 ppmv. The first aluminum-containing compound can react with at least a portion of any residual anti-static agent that remains within the reactor to produce a first reaction product that can include ethane and at least one additional product. At least a portion of the ethane in the first reaction product can be removed from the reactor. Water can be introduced into the reactor. The water can react with at least a portion of any residual first aluminum-containing compound remaining within the reactor to produce a second reaction product that can include ethane and a first alkylaluminum hydroxide. At least a portion of the ethane in the second reaction product can be removed from the reactor. A seedbed produced with a Ziegler-Natta catalyst can be introduced into the reactor. A second carrier gas can be introduced into the reactor and the reactor can be vented to dry the seed bed to a water concentration of ≤20 ppmv. A second aluminum-containing compound can be introduced into the reactor. The second aluminum-containing compound can react with at least a portion of any residual water within the reactor to produce a third reaction product that can include ethane and a second alkylaluminum hydroxide. At least a portion of the ethane in the third reaction product can be removed from the reactor. A second olefin can be introduced into the reactor. A plurality of Ziegler-Natta catalyst particles and a third carrier gas can be introduced into the reactor under conditions effective to maintain the Ziegler-Natta catalyst particles in a fluidized state and to polymerize the second olefin in the presence of the Ziegler-Natta catalyst particles to produce a second polymer product.

In other embodiments, a process for transitioning from a first Ziegler-Natta catalyst to a second Ziegler-Natta catalyst in gas phase polymerization reactor can include introducing a first olefin, a first aluminum-containing compound, a first carrier gas, and a plurality of first Ziegler-Natta catalyst particles into the reactor under conditions effective to maintain the first Ziegler-Natta catalyst particles in a fluidized state and to polymerize the first olefin in the presence of the first Ziegler-Natta catalyst particles to produce a first polymer product. A kill agent can be introduced into the reactor to stop polymerization of the first olefin within the reactor. Introduction of the first Ziegler-Natta catalyst particles, the first aluminum-containing compound, and the first olefin into the reactor can be stopped. A first portion of the first olefin can be removed from the reactor. The first polymer product and the first Ziegler-Natta catalyst particles can be removed from the reactor. A concentration of the first olefin within the reactor can be reduced to ≤1,000 ppmv. Water can be introduced into the reactor after the concentration of the first olefin within the reactor is reduced to ≤1,000 ppmv. The water can react with at least a portion of any residual first aluminum-containing compound remaining within the reactor to produce a first reaction product that can include ethane and a first alkylaluminum hydroxide. At least a portion of the ethane in the first reaction product can be removed from the reactor. A seedbed produced with a second Ziegler-Natta catalyst can be introduced into the reactor. A second carrier gas can be introduced into the reactor and the reactor can be vented to dry the seed bed to a water concentration of ≤20 ppmv. A second aluminum-containing compound can be introduced into the reactor. The second aluminum-containing compound can react with at least a portion of any residual water within the reactor to produce a second reaction product that can include ethane and a second alkylaluminum hydroxide. At least a portion of the ethane in the second reaction product can be removed from the reactor. A second olefin can be introduced into the reactor. It can be ensured that the reactor contains at least 500 ppmw of the second aluminum-containing compound based on a weight of the seedbed in the reactor. A plurality of second Ziegler-Natta catalyst particles, a third aluminum-containing compound, and a third carrier gas can be introduced into the reactor containing the at least 500 ppmw of the second aluminum-containing compound under conditions effective to maintain the Ziegler-Natta catalyst particles in a fluidized state and to polymerize the second olefin in the presence of the second Ziegler-Natta catalyst particles to produce a second polymer product.

### BRIEF DESCRIPTION OF THE DRAWING

FIG. 1 is a schematic diagram of a gas phase polymerization system, according to one or more embodiments described.

FIG. 2 shows polymerization reactor data for a comparative start-up process upon switching from a metallocene catalyst to a Ziegler-Natta catalyst.

FIG. 3 shows polymerization reactor data for an inventive start-up process upon switching from a metallocene catalyst to a Ziegler-Natta catalyst.

### DETAILED DESCRIPTION

Various specific embodiments, versions and examples of the invention will now be described, including preferred embodiments and definitions that are adopted herein for purposes of understanding the claimed invention. While the following detailed description gives specific preferred embodiments, those skilled in the art will appreciate that these embodiments are exemplary only, and that the invention may be practiced in other ways. For purposes of determining infringement, the scope of the invention will refer to any one or more of the appended claims, including their equivalents, and elements or limitations that are equivalent to those that are recited. Any reference to the “invention” may refer to one or more, but not necessarily all, of the inventions defined by the claims.

As used herein, the indefinite article “a” or “an” shall mean “at least one” unless specified to the contrary or the context clearly indicates otherwise. Thus, embodiments using “an alpha-olefin” include embodiments where one, two or more alpha-olefins are used, unless specified to the contrary or the context clearly indicates that only one alpha-olefin is used.

Unless otherwise indicated, all numbers indicating quantities in this disclosure are to be understood as being modified by the term “about” in all instances. It should also be understood that the precise numerical values used in the specification and claims constitute specific embodiments.

As used herein, “wt %” means percentage by weight, “vol %” means percentage by volume, “mol %” means percentage by mole, “ppm” means parts per million, and “ppm wt” and “wppm” are used interchangeably and mean parts per million on a weight basis. All concentrations herein, unless otherwise stated, are expressed on the basis of the total amount of the composition in question.

An “olefin” is a linear, branched, or cyclic compound of carbon and hydrogen having at least one double bond. For purposes of this specification and the claims appended thereto, when a polymer or copolymer is referred to as including an olefin, e.g., ethylene and at least one C₃ to C₂₀ α-olefin, the olefin present in such polymer or copolymer is the polymerized form of the olefin. For example, when a copolymer is said to have an “ethylene” content of about 35 wt % to about 55 wt %, it is understood that the repeating unit/mer unit or simply unit in the copolymer is derived from ethylene in the polymerization reaction and the derived units are present at about 35 wt % to about 55 wt %, based on a weight of the copolymer. For the purposes of the present disclosure, ethylene shall be considered an α-olefin.

A “polymer” has two or more repeating mer units, or simply units. A “homopolymer” is a polymer having units that are the same. A “copolymer” is a polymer having two or more units that are different from each other. A “terpolymer” is a polymer having three units that are different from each other. The term “different” as used to refer to units indicates that the units differ from each other by at least one atom or are different isomerically. The definition of copolymer, as used herein, includes terpolymers and the like. Likewise, the definition of polymer, as used herein, includes homopolymers, copolymers, and the like. Furthermore, the terms “polyethylene copolymer”, “ethylene copolymer”, and “ethylene-based polymer” are used interchangeably to refer to a copolymer that includes at least 50 mol % of units derived from ethylene.

For the purposes of this disclosure, the nomenclature of elements is pursuant to the NEW NOTATION version of the Periodic Table of Elements as provided in Hawley's Condensed Chemical Dictionary, 16^{th} Ed., John Wiley & Sons, Inc., (2016), Appendix V unless otherwise noted.

The term, “catalyst” can be used interchangeably with the terms “catalyst compound,” “catalyst precursor,” “transition metal compound,” “transition metal complex,” and “precatalyst.”

The terms “anti-static agent”, “continuity additive”, “continuity aid”, and “antifoulant agent” refer to compounds or mixtures of compounds, such as solids and/or liquids, that are useful in polymerization to reduce or eliminate fouling of the reactor, where fouling can be manifested by any number of phenomena including sheeting of the reactor walls, plugging of inlet and outlet lines, formation of large agglomerates, or other forms of reactor upsets known in the art. The antistatic agent can be used as a part of the catalyst composition or introduced directly into the reactor independent of the catalyst composition. In some embodiments, the continuity additive can be supported on a support that also supports one or more catalysts.

As described herein, a “seed bed” refers to one or more materials, including but not limited to, granular polymers composed of polyolefin product produced via a catalyst that can include a catalyst such as a Ziegler-Natta catalyst or a metallocene catalyst. The seed bed can have a narrow or wide range of particle size distribution. In some embodiments, the seed bed can have or does not have the same polymer properties as of the polymer product to be produced. The one or more materials (also referred to sometimes as “seed bed material”) can be stored in silos or hopper cars and loaded into a polymerization reactor or remain in the reactor from a previous polymerization process. Often the stored seed bed is exposed to air and moisture.

“Alkoxides” include an oxygen atom bonded to an alkyl group that is a C₁ to C₁₀ hydrocarbyl. The alkyl group may be straight chain, branched, or cyclic. The alkyl group may be saturated or unsaturated. In at least one embodiment, the alkyl group may include at least one aromatic group.

“Asymmetric” as used in connection with the indenyl compounds described herein means that the substitutions at the 4 positions are different, or the substitutions at the 2 positions are different, or the substitutions at the 4 positions are different and the substitutions at the 2 positions are different.

The properties and performance of the polyethylene can be advanced by the combination of: (1) varying one or more reactor conditions such as reactor temperature, hydrogen concentration, comonomer concentration, and so on; and (2) selecting and feeding two catalysts having a first catalyst and second catalyst trimmed or not with the first catalyst or the second catalyst.

In at least one embodiment, the catalyst can include a first catalyst that can be a high molecular weight component and a second catalyst that can be a low molecular weight component. In other words, the first catalyst can provide primarily for a high molecular-weight portion of the polymer and the second catalyst can provide primarily for a low molecular weight portion of the polymer. In at least one embodiment, two catalysts can be present in a catalyst pot of a reactor system, and a molar ratio of the first catalyst to the second catalyst can be from 99:1 to 1:99, such as from 90:10 to 10:90, such as from 85:15 to 50:50, such as from 75:25 to 50:50, such as from 60:40 to 40:60. The first catalyst and/or the second catalyst can be added to a polymerization process as a trim catalyst to adjust the molar ratio of the first catalyst to the second catalyst. In at least one embodiment, the first catalyst and the second catalyst can each be a metallocene catalyst.

A general description of an exemplary polymerization system and process will now be described followed by a description of the processes that can be used to transition from a metallocene catalyst to a Ziegler-Natta catalyst and processes that can be used to transition from a first Ziegler-Natta catalyst to a second Ziegler-Natta catalyst.

### Polymerization System and Process

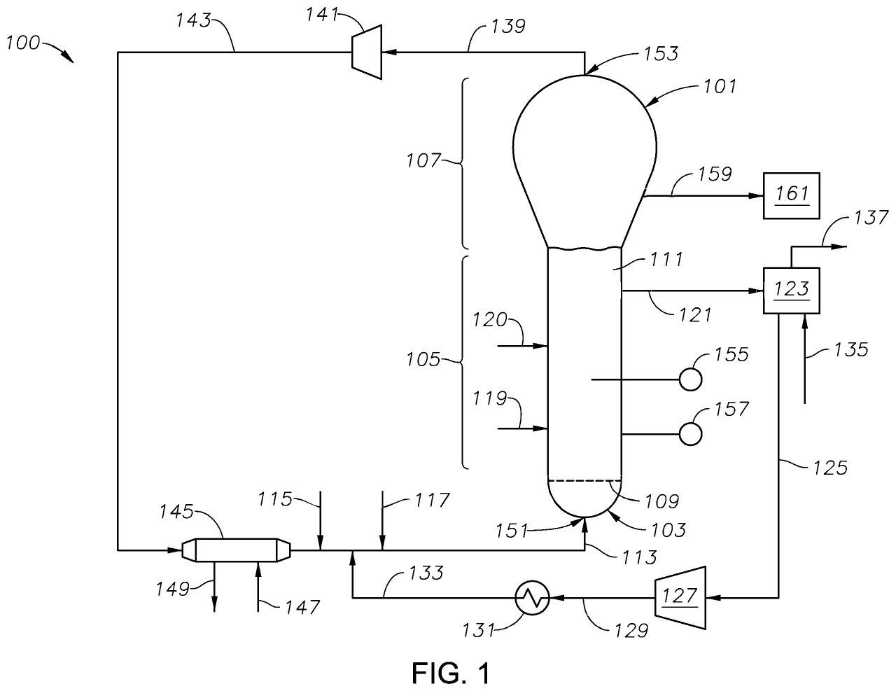

FIG. 1 is a schematic diagram of a polymerization system 100, according to one or more embodiments. The polymerization system 100 can be used to polymerize one or more first olefins in the presence of a first catalyst, to transition to a second catalyst, and then to polymerize one or more second olefins in the presence of the second catalyst. The one or more first olefins and the one or more second olefins can be the same or different with respect to one another. The polymerization system 100 can include a fluidized bed reactor 101. The fluidized bed reactor 101 can have a bottom end 103, a straight section 105, a top expanded section 107, and a distributor plate 109 within the straight section 105. A fluidized bed 111 of granular polymer (once formed) and catalyst particles can be contained within the straight section 105 and can optionally extend some into the top expanded section 107. The bed 111 can be fluidized by the steady flow of recycle gas through the distributor plate 109. The recycle gas can enter the fluidized bed reactor 101 through line 113, additional reaction and inert gases (including continuity additives) can be added in adjustable ratios via line 115. Aluminum alkyl (optional) can be added through line 117. The flow rate of the recycle gas can be regulated to maintain circulation of the fluidized bed 111. In some embodiments, a recycle gas velocity of from 0.3 m/sec. 0.46 m/second, or 0.6 m/sec to 0.7 m/second, 0.8 m/sec, or 0.9 m/sec can be used to maintain the fluidized bed 111 within the reactor 101 while operating the reactor 101 at a total pressure of about 4,200 kPa-absolute or less, e.g., 700 kPa-absolute, 1,300 kPa-absolute, or 1,700 kPa-absolute to 2,500 kPa-absolute, 2,800 kPa-absolute, or 3,500 kPa absolute.

The polymerization system 100 can also include one or more catalyst lines 119 for controlling the addition of polymerization catalyst to a reaction zone (not shown) within fluidized bed 111, and generally within straight section 105. Within the reaction zone, the catalyst particles react with reaction gases including an olefin monomer (e.g., ethylene) and optionally one or more comonomers and/or one or more other reaction gases (e.g., hydrogen) to produce the granular polymer particles. As new polymer particles are produced, other polymer particles can be continuously or periodically withdrawn from the fluidized bed 111 through a product discharge line 121 to product recovery system 123. In some embodiments, the fluidized bed 111 can be maintained at a relatively constant height by withdrawing a portion of the fluidized bed 111 at a rate equal to the rate of formation of particulate product. The product can be removed continuously or nearly continuously via a series of valves (not shown) into a fixed volume chamber (not shown), which can be simultaneously vented back to the reactor. The fixed volume chamber and venting back to the reactor can provide for highly efficient removal of the product, while recycling a large portion of the unreacted gases back to the reactor.

Unreacted olefins and a continuity additive composition within the product recovery system can be removed via line 125, compressed in compressor 127, and travel via line 129 to heat exchanger 131 to be cooled before being recycled (e.g., via line 133) to line 113. In some embodiments, the particles within product recovery system 123 can be degassed (or “purged”) with a flow of inert gas such as nitrogen through line 135 to remove substantially all of the dissolved hydrocarbon materials. In some instances, the polymer granules can be treated with a small stream of humidified nitrogen to deactivate trace quantities of residual catalyst. The purge gas can be removed via line 151 to be vented to flare or recycled with further processing.

The polymerization system 100 can also include a cooling loop that can include a first recycle gas line 139, compressor 141, a second recycle gas line 143, and a cooling system 145 (such as a circulating gas cooler), coupled with the fluidized bed reactor 101. The cooling system 145 can accept cooling water via line 147 and expel heated water via line 149. The cooling of the recycle gas can be used to cool polymerization system 100 to reduce or eliminate issues that can arise from exothermic polyolefin production. During operation, the cooled circulating gas from cooling system 145 can flow via line 113 through inlet 151 into the fluidized bed reactor 101 and propagate upward through fluidized bed 111 and out from the fluidized bed reactor 101 via outlet 153.

The top expanded section 107, which can also be referred to as a “velocity reduction zone”, can be designed to reduce the quantities of particle entrainment in the recycle gas line from the fluidized bed. The diameter of the top expanded section 107 generally increases with the distance from straight section 105. The increased diameter causes a reduction in the speed of the gas stream, which allows most or even all of the entrained particles to settle back into the fluidized bed 111, thereby minimizing or eliminating the quantities of solid particles that are “carried over” from the fluidized bed 111 through the recycle gas line 139. In some instances, a screen (not shown) can be included upstream of the compressor 141 to remove larger material.

The composition of reactor gas within the reactor 101 can be measured by removal of gas from upper portion 107 via line 159 to a gas chromatograph (“GC”) system 161. The GC system 161 can also be connected by lines (not shown) other than line 159 to other parts of polymerization system 100, such as recycle gas line 139, compressor 141, line 143, or any combination thereof. One or more temperature sensors 155 can be located in the fluidized bed. The fluidized bed reactor 101 can also include one or more skin temperature sensors 157 that can be mounted in positions along a wall of the straight section 105 of the fluidized bed reactor 101 so as to protrude into the bed from the reactor wall by a small amount (e.g., about one eighth to one quarter of an inch). In some embodiments, the temperature sensors 155 and/or 157 can be used with a control system and the cooling loop to control the temperature of the fluidized bed 111.

The polymerization system 100 can also include one or more seedbed lines 120 for introducing a seedbed into the fluidized bed reactor 101 before initiation of polymerization therein. When transitioning between two different catalysts, the fluidized bed 111 that includes a first polymer and the first catalyst can be completely removed via line 121 and sent to storage. Once the fluidized bed 111 that includes the first polymer and the first catalyst has been removed a seedbed produced with a second catalyst can be introduced via line 120 into the fluidized bed reactor 101. A more detailed description of the processes for transitioning from a first catalyst to a second catalyst are discussed below.

Transitioning from a Metallocene Catalyst to a Ziegler-Natta Catalyst

In some embodiments, a first olefin, an anti-static agent, a first carrier gas, and a plurality of metallocene catalyst particles can be introduced into a gas phase polymerization reactor under conditions effected to maintain the metallocene catalyst particles in a fluidized state and to polymerize the first olefin in the presence of the metallocene catalyst particles to produce a first polymer product. In some embodiments, a temperature within the reactor can be greater than 30° C., greater than 40° C., greater than 50° C., greater than 90° C., greater than 100° C., and/or greater than 110° C., or higher. In general, the reactor temperature can be operated at a suitable temperature taking into account the sintering temperature of the polymer product within the reactor. Thus, the upper temperature limit in one embodiment can be the melting temperature (or slightly below) of the polymer produced in the reactor. Higher temperatures can result in narrower molecular weight distributions that can be improved by the addition of a catalyst, or other co-catalysts. Typical conditions include a temperature of 70° C. or 80° C. to 100° C. or 110° C., and a pressure of 1,500 kPa-absolute to 3,000 kPa-absolute, such as 1,700 kPa-absolute to 2,600 kPa-absolute, or 2,100 kPa-absolute to 2,300 kPa-absolute. The first carrier gas can be or can include, but is not limited to, molecular nitrogen.

In some embodiments, one or more pentanes, one or more butanes, ethane, methane, hydrogen, i.e., molecular hydrogen, or any mixture thereof can be introduced into the reactor with the first olefin, the anti-static agent, the first carrier gas, and the plurality of metallocene catalyst particles. The alkanes can serve as induced condensing agents as is well-known in the art. The hydrogen can be used in the polymerization process to help control or otherwise adjust the final properties of the polyolefin, such as described in the “Polypropylene Handbook, at pages 76-78 (Hanser Publishers, 1996). Using certain catalysts, increasing concentrations (partial pressures) of hydrogen can increase a flow index such as the melt index of the polyethylene polymer. The melt index can thus be influenced by the hydrogen concentration. The amount of hydrogen in the reactor can be expressed as a mole ratio relative to the total polymerizable monomer, for example, ethylene, or a blend of ethylene and hexene or propylene. The amount of hydrogen used in the polymerization process can be an amount necessary to achieve the desired melt index of the final polyolefin polymer. For example, the mole ratio of hydrogen to total monomer (H₂:monomer) can be 0.0001 or greater, 0.0005 or greater, or 0.001 or greater and can be 10 or less, 5 or less, 3 or less, 1 or less, or 0.10 or less. A range for the mole ratio of hydrogen to monomer can include any combination of any upper mole ratio limit with any lower mole ratio limit described herein. In some embodiments, the amount of hydrogen in the reactor at any time can range to up to 5,000 ppm, up to 4,000 ppm in another embodiment, up to 3,000 ppm, or from 50 ppm to 5,000 ppm, or from 50 ppm to 2,000 ppm in another embodiment. In some embodiments, the reactor can be capable of producing from 10 kg per hour (kg/hr), greater than 455 kg/hr, greater than 4,540 kg/hr, greater than 11,300 kg/hr, greater than 15,900 kg/hr, greater than 22,700 kg/hr, or greater than 29,000 kg/hr to 45,500 kg/hr of polymer.

When it is desired to transition from the plurality of metallocene catalyst particles to the Ziegler-Natta catalyst, introduction of the metallocene catalysts particles and the anti-static agent into the reactor can be stopped. Once introduction of the metallocene catalyst particles into the reactor is stopped the polymerization within the reactor can start to die off. A kill agent can be introduced into the reactor to accelerate the die off of the polymerization within the reactor. In some embodiments, the kill agent can be or can include, but is not limited to, carbon monoxide, carbon dioxide, or a mixture thereof.

Once the polymerization has died off a sufficient amount, introduction of the first olefin into the reactor can be stopped and the reactor can begin to de-inventory from an operating pressure, e.g., about 2,100 kPa-absolute to about 2,500 kPa-absolute, to a de-inventory pressure, e.g., about 700 kPa-absolute to about 800 kPa-absolute. Reducing the pressure within the reactor can remove reactive hydrocarbon, e.g., a first portion of the first olefin, and nitrogen within the reactor. The reactor contents removed from the reactor can be sent to a flare. Once the reactor reaches the de-inventory pressure, the reactor can be pressurized with an inert gas, e.g., nitrogen, to a bed removal pressure, e.g., 1,900 kPa-absolute to 2,100 kPa-absolute. Once the pressure reaches the bed removal pressure the fluidized bed, e.g., the first polymer product, the metallocene catalyst particles, and the anti-static agent, can be removed from the reactor and sent to storage.

Once the bed has been removed, fresh inert gas, e.g., nitrogen, can be introduced to the reactor and venting can be initiated to dilute any remaining hydrocarbons within the polymerization system. Said another way, once the bed has been removed from the reactor a second portion of the first olefin within the reactor can be removed therefrom. The introduction of fresh inert gas and venting can be continued until the concentration of hydrocarbons falls close to zero. For example, the introduction of the fresh inert gas and venting can be continued until the concentration of the first olefin within the polymerization system falls to ≤1,500 ppmv, ≤1,250 ppmv, ≤1,000 ppmv, ≤900 ppmv, ≤800 ppmv, ≤700 ppmv, ≤600 ppmv, ≤500 ppmv, ≤400 ppmv, or ≤300 ppmv.

Once the hydrocarbon concentration has fallen close to zero, the circulating gas within the polymerization system can be adjusted (if needed) to a temperature of 75° C. or more and a first aluminum-containing compound can be introduced into the reactor. The amount of the first aluminum-containing compound introduced into the reactor can be from 1 g/m³ of reactor volume, 2 g/m³ of reactor volume, 2.5 g/m³ of reactor volume, 5 g/m³ of reactor volume, 7 g/m³ of reactor volume, or 10 g/m³ of reactor volume to 15 g/m³ of reactor volume, 17 g/m³ of reactor volume, 20 g/m³ of reactor volume, 23 g/m³ of reactor volume, 25 g/m³ of reactor volume, 30 g/m³ of reactor volume, or more. Once the first aluminum-containing has been introduced into the reactor, the first aluminum-containing compound can be circulated through the polymerization system for a first period of time of ≥0.5 hr, ≥1 hr, ≥1.5 hr, ≥2 hr, ≥3 hr, ≥4 hr, ≥5 hr or more.

The first aluminum-containing compound can react with at least a portion of any residual anti-static agent that may remain within the reactor to produce a first reaction product that can include ethane and at least one additional product. In some embodiments, the at least one additional compound can be or can include, but is not limited to, a dialkylaluminum-(μ-oxo)-aluminum distearate, one or more alkylaluminum alkoxides, or the like. In some embodiments, the anti-static agent can be one or more metal-carboxylate salts and the first aluminum-containing compound can be triethylaluminum (TEAL) and the reaction products can be ethane and one or more dialkylaluminum-(μ-oxo)-aluminum distearates. In other embodiments, the anti-static agent can be one or more ethoxylated amines and the aluminum-containing compound can be triethylaluminum and the reaction product can be ethane and one or more alkylaluminum alkoxides. In still other embodiments, the anti-static agent can be one or more metal-carboxylate salt and one or more ethoxylated amines and the aluminum-containing compound can be triethylaluminum and the reaction products can be ethane, one or more dialkylaluminum-(μ-oxo)-aluminum distearates, and one or more alkylaluminum alkoxides.

In some embodiments, after circulating the first aluminum-containing compound through the polymerization system for the first period of time an additional quantity of the first aluminum-containing compound can optionally be introduced into the reactor. In some embodiments, the optional additional quantity of the first aluminum-containing compound introduced into the reactor can be 0.1 g/m³ of reactor volume, 0.3 g/m³ of reactor volume, 0.5 g/m³ of reactor volume, 0.7 g/m³ of reactor volume, or 1 g/m³ of reactor volume to 1.5 g/m³ of reactor volume, 1.7 g/m³ of reactor volume, 2 g/m³ of reactor volume, 2.5 g/m³ of reactor volume, 2.7 g/m³ of reactor volume, 3 g/m³ of reactor volume, 3.3 g/m³ of reactor volume, 3.5 g/m³ of reactor volume, 3.7 g/m³ of reactor volume, 4 g/m³ of reactor volume, or more. In some embodiments, the amount of additional first aluminum-containing compound introduced into the reactor can be less than the amount of the first aluminum-containing compound introduced initially introduced into the reactor. If the additional quantity of the first aluminum-containing compound has been introduced into the reactor, the additional quantity of the first aluminum-containing compound can be circulated through the polymerization system for a second period of time of ≥0.2 hr, ≥0.5 hr, ≥0.7 hr, ≥1 hr, ≥1.3 hr, ≥1.5 hr, 1.7 hr, 2 hr or more.

During the introduction and circulation of the first aluminum-containing compound within the polymerization system the evolution of ethane within the reactor can be monitored. When evolution of ethane within the reactor stops it can be concluded that essentially all of the residual anti-static agent capable of reacting with the first aluminum-containing compound within the reactor has been reacted with the first aluminum-containing compound. Once the evolution of ethane within the reactor stops or has slowed to below a pre-determined rate, at least a portion of the reactor contents, e.g., ethane and nitrogen, can be removed and sent to flare. For example, the reactor can be returned to the de-inventory pressure, e.g., about 700 kPa-absolute to about 800 kPa-absolute.

Once a sufficient amount of the reactor contents, e.g., ethane and nitrogen, has been sent to flare water can be introduced into the reactor. In some embodiments, the amount of water introduced into the reactor can be sufficient to ensure the reactor contains ≥250 ppmv of moisture, ≥300 ppmv of moisture, ≥350 ppmv of moisture, ≥400 ppmv of moisture, ≥450) ppmv of moisture, ≥500 ppmv of moisture, ≥550 ppmv of moisture, or ≥600 ppmv of moisture. The water can react with any first aluminum-containing compound that may still be within the reactor to produce a second reaction product that can include ethane and a first alkylaluminum hydroxide. After the water is introduced into the reactor, the water and inert gas, e.g., nitrogen can be circulated through the polymerization system for 30 minutes, 1 hour, 1.5 hours, 1 hours, 2.5 hours, or 3 hours to 3.5 hours, 4 hours, 4.5 hours, 6 hours, or more. Once the water and inert gas have circulated thought the polymerization system for a sufficient period of time, the reactor can be purged with pure inert gas, e.g., nitrogen, to remove at least a portion of the ethane in the second reaction product from the reactor.

A seedbed produced with a Ziegler-Natta catalyst can be introduced into the reactor. In some embodiments, the cycle gas compressor can be stopped and the reactor can be depressurized by directing the reactor contents to the flare. The seedbed produced with the Ziegler-Natta catalyst can be introduced into the depressurized reactor using air or an inert gas, e.g., nitrogen as the conveying fluid. Once the seed bed has been introduced into the reactor, the reactor can be pressure leak tested and purged with an inert gas, e.g., nitrogen, while venting to make the reactor essentially oxygen free if the seedbed was transferred into the reactor via air. In some embodiments, the temperature within the reactor can be adjusted, if needed, to a temperature of 75° C. to 87° C., e.g., 80° C. to 82° C. Purging the reactor with the inert gas can be used to dry the seedbed to a water concentration of ≤60 ppmv, ≤50 ppmv, ≤40 ppmv, ≤30 ppmv, ≤20 ppmv, ≤15 ppmv, ≤10 ppmv, or ≤5 ppmv.

Once the water concentration within the seedbed has been reduced to the desired amount a second aluminum-containing compound can be introduced into the reactor. The second aluminum-containing compound can react with at least a portion of any residual water within the reactor to produce a third reaction product that can include ethane and a second alkylaluminum hydroxide. In some embodiments, the amount of the second aluminum-containing compound can be introduced into the reactor in an amount sufficient to provide ≥ 500 ppmw of the second aluminum-containing compound based on a weight of the seedbed produced with the Ziegler-Natta catalyst in the reactor. In other embodiment, the amount of the second aluminum-containing compound can be introduced into the reactor in an amount sufficient to provide 600 ppmw, 700 ppmw, or 800 ppmw to 900 ppmw, 1,000 ppmw, or 1,100 ppmw of the second aluminum-containing compound, based on a weight of the seedbed produced with the Ziegler-Natta catalyst. Once the desired amount of the second aluminum-containing compound has been introduced into the reactor, the contents within the polymerization system can be circulated for 30 minutes, 45 minutes, 1 hour, 1.5 hours, or 2 hours to 2.5 hours, 3 hours, 4 hours, or more.

Once the second aluminum-containing compound has been circulated within the polymerization system for the desired period of time, a second olefin can be introduced into the reactor. Once the second olefin has been introduced into the reactor a plurality of Ziegler-Natta catalyst particles and a third carrier gas can be introduced into the reactor under conditions effective to maintain the Ziegler-Natta catalyst particles in a fluidized state and to polymerize the second olefin in the presence of the Ziegler-Natta catalyst particles to produce a second polymer product. In some embodiments, the amount of the second aluminum-containing compound can be confirmed to be ≥500 ppmw; ≥600 ppmw; ≥700 ppmw; ≥800 ppmw; ≥900 ppmw; ≥1,000 ppmw; ≥1,050 ppmw; ≥1,100 ppmw, ≥1,150 ppmw; or ≥1,200 ppmw of the second aluminum-containing compound, based on a weight of the seedbed produced with the Ziegler-Natta catalyst in the reactor. Typical conditions can include a temperature of 70° C. to 110° C. and a pressure of 1,500 kPa-absolute to 3,000 kPa-absolute, such as 1,700 kPa-absolute to 2,600 kPa-absolute, or 2,100 kPa-absolute to 2,300 kPa-absolute. The second carrier gas can be or can include, but is not limited to, molecular nitrogen.

In some embodiments, the anti-static agent can be introduced into the reactor in the form of a mixture that can include the anti-static agent and a mineral oil. The mineral oil can at least partially coat the anti-static agent. After removing the second portion of the first olefin from the reactor and before introducing the first aluminum-containing compound into the reactor the process can include introducing a one or more C₄ to C₆ alkanes into the reactor and circulating the one or more C₄ to C₆ alkanes within the reactor to contact and remove at least a portion of any mineral oil at least partially coated on the anti-static agent. Without wishing to be bound by theory, it is believed that the mineral oil at least partially coated on the anti-static agent can inhibit if not prevent the first aluminum-containing compound from being able to react with at least a portion of any residual anti-static agent that may remain within the reactor.

Process for Transitioning from a First Ziegler-Natta Catalyst to a Second Ziegler-Natta Catalyst

In some embodiments, a first olefin, a first aluminum-containing compound, a first carrier gas, and a plurality of first Ziegler-Natta catalyst particles can be introduced into the reactor under conditions effective to maintain the first Ziegler-Natta catalyst particles in a fluidized state and to polymerize the first olefin in the presence of the first Ziegler-Natta catalyst particles to produce a first polymer product. In some embodiments, a temperature within the reactor can be greater than 30° C., greater than 40° C., greater than 50° C., greater than 90° C., greater than 100° C., greater than 110° C., greater than 120° C., greater than 150° C., or higher. In general, the reactor temperature can be operated at a suitable temperature taking into account the sintering temperature of the polymer product within the reactor. Thus, the upper temperature limit in one embodiment can be the melting temperature (or slightly below) of the polymer produced in the reactor. Higher temperatures can result in narrower molecular weight distributions that can be improved by the addition of a catalyst, or other co-catalysts. Typical conditions include a temperature of 70° C. to 110° C. and a pressure of 1,500 kPa-absolute to 3,000 kPa-absolute, such as 1,700 kPa-absolute to 2,600 kPa-absolute, or 2,100 kPa-absolute to 2,300 kPa-absolute. The first carrier gas can be or can include, but is not limited to, molecular nitrogen.

In some embodiments, when it is desired to transition from the first Ziegler-Natta catalyst to a second Ziegler-Natta catalyst a kill agent can be introduced into the reactor to stop polymerization of the first olefin within the reactor. The kill agent can be or can include, but is not limited to, carbon monoxide, carbon dioxide, or a mixture thereof. In some embodiments, once the kill agent has been introduced into the reactor and the rate of polymerization has decreased to a desired level, introduction of the first Ziegler-Natta catalyst particles, the first aluminum-containing compound, and the first olefin into the reactor can be stopped. In other embodiments, introduction of the first Ziegler-Natta catalyst particles, the first aluminum-containing compound, and the first olefin into the reactor can be stopped and then the kill agent can be introduced into the reactor.

After introduction of the kill agent and after stopping the introduction of the first Ziegler-Natta catalyst particles, the first aluminum-containing compound, and the first olefin into the reactor, a first portion of the first olefin can be removed from the reactor. Once the kill agent has been introduced into the reactor the reactor can begin to deinventory from an operating pressure, e.g., about 2,100 kPa-absolute to about 2,300 kPa-absolute, to a de-inventory pressure, e.g., about 700 kPa-absolute to about 800 kPa-absolute. Reducing the pressure within the reactor can remove reactive hydrocarbon(s), e.g., a first portion of the first olefin, and nitrogen within the reactor. The reactor contents removed from the reactor can be sent to a flare. Once the reactor reaches the de-inventory pressure, the reactor can be pressurized with an inert gas, e.g., nitrogen, to a bed removal pressure, e.g., 1,900 kPa-absolute to 2,100 kPa-absolute. Once the pressure reaches the bed removal pressure the fluidized bed, e.g., the first polymer product, and the first Ziegler-Natta catalyst, can be removed from the reactor and sent to storage.

Once the bed has been removed, fresh inert gas, e.g., nitrogen, can be introduced to the reactor and venting can be initiated to dilute any remaining first olefin within the polymerization system. Said another way, once the bed has been removed from the reactor a second portion of the first olefin within the reactor can be removed therefrom. The introduction of fresh inert gas and venting can be continued until the concentration of remaining first olefin falls close to zero. For example, the introduction of the fresh inert gas and venting can be continued until the concentration of the remaining first olefin within the polymerization reactor falls to ≤1,500 ppmv, ≤1,250 ppmv, ≤1,000 ppmv, ≤900 ppmv, ≤800 ppmv, ≤700 ppmv, ≤ 600 ppmv, ≤500 ppmv, ≤400 ppmv, or ≤300 ppmv.

Once a sufficient amount of the reactor contents, e.g., ethylene and nitrogen, has been sent to flare, water can be introduced into the reactor. In some embodiments, the amount of water introduced into the reactor can be sufficient to ensure the reactor contains ≥250 ppm of moisture, ≥300 ppm of moisture, ≥350 ppm of moisture, ≥400 ppm of moisture, ≥450 ppm of moisture, ≥500 ppm of moisture, ≥550 ppm of moisture, or ≥600 ppm of moisture. The water can react with at least a portion of any first aluminum-containing compound that may still be within the reactor to produce a second reaction product that can include an alkane (e.g., ethane, propane, butane, hexane) and a first alkylaluminum hydroxide. After the water is introduced into the reactor, the water and inert gas, e.g., nitrogen can be circulated through the polymerization system for 30 minutes, 1 hour, 1.5 hours, 2 hours, 2.5 hours, or 3 hours to 3.5 hours, 4 hours, 4.5 hours, 6 hours, or more. Once the water and inert gas have circulated thought the polymerization system for a sufficient period of time, the reactor can be purged with pure inert gas, e.g., nitrogen. At this point, an opportunity for maintenance of the reactor is available, e.g., prior to loading new seedbed.

A seedbed produced with a second Ziegler-Natta catalyst can be introduced into the reactor. In some embodiments, the cycle gas compressor can be stopped and the reactor can be depressurized by directing the reactor contents to the flare. The seedbed produced with the second Ziegler-Natta catalyst can be introduced into the depressurized reactor using air or an inert gas, e.g., nitrogen as the conveying fluid. Once the seed bed has been introduced into the reactor, the reactor can be pressure leak tested and purged with a second inert gas, e.g., molecular nitrogen, while venting to make the reactor essentially oxygen free if the seedbed was transferred into the reactor via air. In some embodiments, the temperature within the reactor can be adjusted, if needed, to a temperature of 75° C. to 90° C., e.g., 80° C. to 85° C. Purging and venting the reactor with the second carrier gas can be used to dry the seedbed to a water concentration of ≤60 ppmv, ≤50 ppmv, ≤40 ppmv, ≤30 ppmv, ≤20 ppmv, ≤15 ppmv, ≤10 ppmv, or ≤5 ppmv.

Once the water concentration within the seedbed has been reduced to the desired amount, e.g., <20 ppmv, a second aluminum-containing compound can be introduced into the reactor. The second aluminum-containing compound can react with at least a portion of any residual water within the reactor to produce a third reaction product that can include ethane (or another alkane, e.g., propane, butane, hexane) and a second alkylaluminum hydroxide. In some embodiments, the amount of the second aluminum-containing compound can be introduced into the reactor in an amount sufficient to provide ≥500 ppmw or ≥530 ppmw of the second aluminum-containing compound based on a weight of the seedbed produced with the second Ziegler-Natta catalyst in the reactor. In other embodiments, the amount of the second aluminum-containing compound can be introduced into the reactor in an amount sufficient to provide 600 ppmw; 700 ppmw, or 800 ppmw to 900 ppmw, 1,000 ppmw; or 1,100 ppmw of the second aluminum-containing compound, based on a weight of the seedbed produced with the second Ziegler-Natta catalyst in the reactor. Once the desired amount of the second aluminum-containing compound has been introduced into the reactor, the contents within the polymerization system can be circulated for 30 minutes, 45 minutes, 1 hour, 1.5 hours, or 2 hours to 2.5 hours, 3 hours, 4 hours, or more.

Once the second aluminum-containing compound has circulated within the polymerization system for the desired period of time, the reactor can be vented while introducing fresh carrier gas, e.g., molecular nitrogen, into the reactor. Once the reactor has been vented, a second olefin can be introduced into the reactor. The process can include ensuring the reactor contains ≥500 ppmw, ≥530 ppmw; ≥550 ppmw; ≥600 ppmw; ≥700 ppmw, or 800 ppmw to 900 ppmw, 1,000 ppmw; or 1,100 ppmw of the second aluminum-containing compound, based on a weight of the seedbed produced with the second Ziegler-Natta catalyst in the reactor.

Once the concentration of the second aluminum-containing compound has been confirmed to be at the desired amount a plurality of second Ziegler-Natta catalyst particles, a third aluminum-containing compound, and a third carrier gas, e.g., molecular nitrogen, can be introduced into the reactor under conditions effective to maintain the second Ziegler-Natta catalyst particles in a fluidized state and to polymerize the second olefin in the presence of the second Ziegler-Natta catalyst particles to produce a second polymer product. Typical conditions can include a temperature of 70° C. to 110° C. and a pressure of 1,500 kPa-absolute to 3,000 kPa-absolute, such as 1,700 kPa-absolute to 2,600 kPa-absolute, or 2,100 kPa-absolute to 2,300 kPa-absolute. The second carrier gas can be or can include, but is not limited to, molecular nitrogen.

### First Olefin and Second Olefin

The first and second olefins can be or can include, but are not limited to, substituted or unsubstituted C₂ to C₄₀ alpha olefins, such as C₂ to C₂₀ alpha olefins, such as C₂ to C₁₂ alpha olefins, such as ethylene, propylene, butene, pentene, hexene, heptene, octene, nonene, decene, undecene, dodecene and isomers thereof. In at least one embodiment, the monomer can include ethylene and one or more optional comonomers selected from propylene or C₄ to C₄₀ olefins, such as C₄ to C₂₀ olefins, such as C₆ to C₁₂ olefins. The C₄ to C₄₀ olefin monomers may be linear, branched, or cyclic. The C₄ to C₄₀ cyclic olefins may be strained or unstrained, monocyclic or polycyclic, and may optionally include heteroatoms and/or one or more functional groups.

In some embodiments, the C₂ to C₄₀ alpha olefin and optional comonomers include ethylene, propylene, butene, pentene, hexene, heptene, octene, nonene, decene, undecene, dodecene, norbornene, norbornadiene, dicyclopentadiene, cyclopentene, cycloheptene, cyclooctene, cyclooctadiene, cyclododecene, 7-oxanorbornene, 7-oxanorbornadiene, substituted derivatives thereof, and isomers thereof, such as hexene, heptene, octene, nonene, decene, dodecene, cyclooctene, 1,5-cyclooctadiene, 1-hydroxy-4-cyclooctene, 1-acetoxy-4-cyclooctene, 5-methylcyclopentene, cyclopentene, dicyclopentadiene, norbornene, norbornadiene, and their respective homologs and derivatives, such as norbornene, norbornadiene, and dicyclopentadiene.

In at least one embodiment, one or more dienes can be present in the polymer product at up to 10 wt %, such as at 0.00001 to 1.0 wt %, such as 0.002 to 0.5 wt %, such as 0.003 to 0.2 wt %, based upon the total weight of the composition. In at least one embodiment 500 ppm or less of diene can be added to the polymerization, such as 400 ppm or less, such as 300 ppm or less. In other embodiments at least 50 ppm of diene is added to the polymerization, or 100 ppm or more, or 150 ppm or more.

Diene monomers include any hydrocarbon structure, such as C₄ to C₃₀, having at least two unsaturated bonds, where at least two of the unsaturated bonds can be readily incorporated into a polymer by either a stereospecific or a non-stereospecific catalyst(s). The diene monomers can be selected from alpha, omega-diene monomers (i.e. di-vinyl monomers). The diolefin monomers are linear di-vinyl monomers, such as those containing from 4 to 30 carbon atoms. Examples of dienes can include, but are not limited to, butadiene, pentadiene, hexadiene, heptadiene, octadiene, nonadiene, decadiene, undecadiene, dodecadiene, tridecadiene, tetradecadiene, pentadecadiene, hexadecadiene, heptadecadiene, octadecadiene, nonadecadiene, icosadiene, heneicosadiene, docosadiene, tricosadiene, tetracosadiene, pentacosadiene, hexacosadiene, heptacosadiene, octacosadiene, nonacosadiene, triacontadiene, 1,6-heptadiene, 1,7-octadiene, 1,8-nonadiene, 1,9-decadiene, 1,10-undecadiene, 1,11-dodecadiene, 1,12-tridecadiene, 1,13-tetradecadiene, and low molecular weight polybutadienes (Mw less than 1000 g/mol). Cyclic dienes include cyclopentadiene, vinylnorbornene, norbornadiene, ethylidene norbornene, divinylbenzene, dicyclopentadiene or higher ring containing diolefins with or without substituents at various ring positions.

### Metallocene Catalyst Particles

As used herein, the term “metallocene catalyst particles” refers to bulky ligand metallocene-type catalyst compounds and catalyst systems. Generally, bulky ligand metallocene-type catalyst compounds include half and full sandwich compounds having one or more bulky ligands bonded to at least one metal atom. Typical bulky ligand metallocene-type compounds are generally described as containing one or more bulky ligand(s) and one or more leaving group(s) bonded to at least one metal atom. In one preferred embodiment, at least one bulky ligand is η-bonded to the metal atom, most preferably η⁵-bonded to the metal atom. The bulky ligands can generally be represented by one or more open, acyclic, or fused ring(s) or ring system(s) or a combination thereof. These bulky ligands, preferably the ring(s) or ring system(s), can typically be composed of atoms selected from Groups 13 to 16 atoms of the Periodic Table of Elements, preferably the atoms can be selected from the group of carbon, nitrogen, oxygen, silicon, sulfur, phosphorous, germanium, boron, aluminum, or any combination thereof. Most preferably the ring(s) or ring system(s) can be composed of carbon atoms such as but not limited to those cyclopentadienyl ligands or cyclopentadienyl-type ligand structures or other similar functioning ligand structure such as a pentadiene, a cyclooctatetraendiyl or an imide. The metal atom can preferably be selected from Groups 3 through 15 and the lanthanide or actinide series of the Periodic Table of Elements. Preferably the metal can be a transition metal from Groups 4 through 12, more preferably Groups 4, 5 and 6, and most preferably the transition metal is from Group 4.

In one embodiment, the bulky ligand metallocene-type catalyst compounds can be represented by the formula (I): L^{A}L^{B}MQₙ, where M can be a metal atom from the Periodic Table of the Elements and can be a Group 3 to 12 metal or from the lanthanide or actinide series of the Periodic Table of Elements, preferably M can be a Group 4, 5 or 6 transition metal, more preferably M can be a Group 4 transition metal, even more preferably M can be zirconium, hafnium or titanium. The bulky ligands, L^{A} and L^{B}, can independently be open, acyclic, or fused ring(s) or ring system(s) such as unsubstituted or substituted, cyclopentadienyl ligands or cyclopentadienyl-type ligands, heteroatom substituted and/or heteroatom containing cyclopentadienyl-type ligands. Non-limiting examples of bulky ligands include cyclopentadienyl ligands, cyclopentaphenanthreneyl ligands, indenyl ligands, benzindenyl ligands, fluorenyl ligands, octahydrofluorenyl ligands, cyclooctatetraendiyl ligands, azenyl ligands, azulene ligands, pentalene ligands, phosphoyl ligands, pyrrolyl ligands, pyrozolyl ligands, carbazolyl ligands, borabenzene ligands, and the like, including hydrogenated versions thereof, for example tetrahydroindenyl ligands. In one embodiment, L^{A} and L^{B} can be any other ligand structure capable of pi-bonding to M, preferably η³-bonding to M and most preferably η⁵-bonding. In yet another embodiment, the atomic molecular weight (MW) of L^{A} or L^{B} exceeds 60 a.m.u., preferably greater than 65 a.m.u. In another embodiment, L^{A} and L^{B} can include one or more heteroatoms, for example, nitrogen, silicon, boron, germanium, sulfur, oxygen and phosphorous, in combination with carbon atoms to form an open, acyclic, or preferably a fused, ring or ring system, for example, a hetero-cyclopentadienyl ancillary ligand. Other L^{A} and L^{B} bulky ligands can include, but are not limited to, bulky amides, phosphides, alkoxides, aryloxides, imides, carbolides, borollides, porphyrins, phthalocyanines, corrins and other polyazomacrocycles. Independently, each L^{A} and L^{B} can be the same or different type of bulky ligand that is bonded to M. In one embodiment of formula (I) only one of either L^{A} or L^{B} can be present.

Independently, each L^{A} and L^{B} can be unsubstituted or substituted with a combination of substituent groups R. Non-limiting examples of substituent groups R include one or more from the group selected from hydrogen, or linear, branched alkyl radicals, or alkenyl radicals, alkynyl radicals, cycloalkyl radicals or aryl radicals, acyl radicals, aroyl radicals, alkoxy radicals, aryloxy radicals, alkylthio radicals, dialkylamino radicals, alkoxycarbonyl radicals, aryloxycarbonyl radicals, carbomoyl radicals, alkyl- or dialkyl-carbamoyl radicals, acyloxy radicals, acylamino radicals, anoylamino radicals, straight, branched or cyclic, alkylene radicals, or any combination thereof. In a preferred embodiment, substituent groups R have up to 50 non-hydrogen atoms, preferably from 1 to 30 carbon, which can also be substituted with halogens or heteroatoms or the like. Non-limiting examples of alkyl substituents R include methyl, ethyl, propyl, butyl, pentyl, hexyl, cyclopentyl, cyclohexyl, benzyl or phenyl groups and the like, including all their isomers, for example tertiary butyl, isopropyl, and the like. Other hydrocarbyl radicals include fluoromethyl, fluroethyl, difluroethyl, iodopropyl, bromohexyl, chlorobenzyl and hydrocarbyl substituted organometalloid radicals including trimethylsilyl, trimethylgermyl, methyldiethylsilyl and the like; and halocarbyl-substituted organometalloid radicals including tris(trifluoromethyl)-silyl, methyl-bis(difluoromethyl)silyl, bromomethyldimethyl-germyl and the like; and disubstituted boron radicals including dimethylboron for example; and disubstituted pnictogen radicals including dimethylamine, dimethylphosphine, diphenylamine, methylphenylphosphine, chalcogen radicals including methoxy, ethoxy, propoxy, phenoxy, methylsulfide and ethylsulfide. Non-hydrogen R substituents include the atoms carbon, silicon, boron, aluminum, nitrogen, phosphorous, oxygen, tin, sulfur, germanium and the like, including olefins such as but not limited to olefinically unsaturated substituents including vinyl-terminated ligands, for example but-3-enyl, prop-2-enyl, hex-5-enyl and the like. Also, at least two R groups, preferably two adjacent R groups, can be joined to form a ring structure having from 3 to 30 atoms selected from carbon, nitrogen, oxygen, phosphorous, silicon, germanium, aluminum, boron or a combination thereof. Also, a substituent group R group such as 1-butanyl can form a carbon sigma bond to the metal M.

Other ligands can be bonded to the metal M, such as at least one leaving group Q. For the purposes of this disclosure, the term “leaving group” is any ligand that can be abstracted from a bulky ligand metallocene-type catalyst compound to form a bulky ligand metallocene-type catalyst cation capable of polymerizing one or more olefin(s). In one embodiment, Q is a monoanionic labile ligand having a sigma-bond to M. Non-limiting examples of Q ligands can include weak bases such as amines, phosphines, ethers, carboxylates, dienes, hydrocarbyl radicals having from 1 to 20 carbon atoms, hydrides or halogens and the like or a combination thereof. In another embodiment, two or more Q ligands can form a part of a fused ring or ring system. Other examples of Q ligands include those substituents for R as described above and including cyclobutyl, cyclohexyl, heptyl, tolyl, trifluromethyl, tetramethylene, pentamethylene, methylidene, methyoxy, ethyoxy, propoxy, phenoxy, bis(N-methylanilide), dimethylamide, dimethylphosphide radicals and the like. Depending on the oxidation state of the metal, the value for n can be 0, 1 or 2 such that formula (I) above represents a neutral bulky ligand metallocene-type catalyst compound.

In one embodiment, the bulky ligand metallocene-type catalyst compounds can include those of formula (I) where L^{A} and L^{B} can bridged to each other by a bridging group, A, such that the formula is represented by formula (II): L^{A}AL^{B}MQₙ. These bridged compounds represented by formula (II) are known as bridged, bulky ligand metallocene-type catalyst compounds. L^{A}, L^{B}, M, Q and n can be as defined above. Non-limiting examples of bridging group A include bridging groups containing at least one Group 13 to 16 atom, often referred to as a divalent moiety such as but not limited to, at least one of a carbon, oxygen, nitrogen, silicon, boron, germanium and tin atom or a combination thereof. Preferably bridging group A can contain a carbon, silicon, iron or germanium atom, most preferably A can contain at least one silicon atom or at least one carbon atom. The bridging group A can also contain substituent groups R as defined above including halogens. Non-limiting examples of bridging group A can be represented by R′₂C, R′₂Si, R′₂SiR′₂Si, R′₂Ge, R′P, R′₂NB where R′ is independently a radical group, which can be a hydride, hydrocarbyl, substituted hydrocarbyl, halocarbyl, substituted halocarbyl, hydrocarbyl-substituted organometalloid, halocarbyl-substituted organometalloid, omega-unsaturated hydrocarbyl, substituted omega-unsaturated hydrocarbyl, di-substituted boron, di-substituted nitrogen, substituted halogen, or halogen; or two or more R′ can be joined to form a ring or ring system. In one embodiment, the bulky ligand metallocene-type catalyst compounds are those where the R substituents on the bulky ligands L^{A} and L^{B} of formulas (I) and (II) can be substituted with the same or different number of substituents on each of the bulky ligands. In another embodiment, the bulky ligands L^{A} and L^{B} of formulas (I) and (II) are different from each other.

Other bulky ligand metallocene-type catalyst compounds and catalyst systems can include those described in U.S. Pat. Nos. 5,064,802, 5,145,819, 5,149,819, 5,243,001, 5,239,022, 5,276,208, 5,296,434, 5,321,106, 5,329,031, 5,304,614, 5,677,401, 5,723,398, 5,753,578, 5,854,363, 5,856,547 5,858,903, 5,859,158 and 5,929,266; PCT publications WO 93/08221, WO 93/08199, WO 95/07140, WO 98/11144, WO 98/41530, WO 98/41529, WO 98/46650, WO 99/02540 and WO 99/14221; and European publications EP-A-0 578 838, EP-A-0 638 595, EP-B-0 513 380, EP-A1-0 816 372, EP-A2-0 839 834, EP-B1-0 632 819, EP-B1-0 748 821 and EP-B1-0 757 996.

In one embodiment, bulky ligand metallocene-type catalyst compounds can include bridged heteroatom, mono-bulky ligand metallocene-type compounds. These types of catalysts and catalyst systems include those described in, for example, PCT publication WO 92/00333, WO 94/07928, WO 91/04257, WO 94/03506, WO 96/00244 and WO 97/15602; and U.S. Pat. Nos. 5,057,475, 5,096,867, 5,055,438, 5,198,401, 5,227,440 and 5,264,405; and European publication EP-A-0 420 436.

In one embodiment, the bulky ligand metallocene-type catalyst compound can be represented by the formula (III): L^{C}AJMQₙ, where M can be a Group 3 to 16 metal atom or a metal selected from the Group of actinides and lanthanides of the Periodic Table of Elements, preferably M can be a Group 4 to 12 transition metal, and more preferably M can be a Group 4, 5 or 6 transition metal, and most preferably M can be a Group 4 transition metal in any oxidation state, especially titanium; L^{C} is a substituted or unsubstituted bulky ligand bonded to M; J is bonded to M; A is bonded to M and J; J is a heteroatom ancillary ligand; and A is a bridging group; Q is a univalent anionic ligand; and n is the integer 0, 1 or 2. In formula (III) above, L^{C}, A, and J can form a fused ring system. In an embodiment, L^{C} of formula (III) can be as defined above for L^{A} and A, M and Q of formula (III) can be as defined above in formula (I). In formula (III) J can be a heteroatom containing ligand in which J is an element with a coordination number of three from Group 15 or an element with a coordination number of two from Group 16 of the Periodic Table of Elements. Preferably, J contains a nitrogen, phosphorus, oxygen or sulfur atom with nitrogen being most preferred.

In another embodiment, the bulky ligand type metallocene-type catalyst compound can be a complex of a metal, preferably a transition metal, a bulky ligand, preferably a substituted or unsubstituted pi-bonded ligand, and one or more heteroallyl moieties, such as those described in U.S. Pat. Nos. 5,527,752 and 5,747,406 and EP Patent No. EP-B1-0 735 057.

In some embodiments, the bulky ligand metallocene-type catalyst compound can be represented by the formula (IV): L^{D}MQ₂(YZ)Xₙ, where M can be a Group 3 to 16 metal, preferably a Group 4 to 12 transition metal, and most preferably a Group 4, 5 or 6 transition metal; L^{D} can be a bulky ligand that can be bonded to M; each Q can be independently bonded to M and Q₂(YZ) can form a unicharged polydentate ligand; A or Q can be a univalent anionic ligand also bonded to M; X can be a univalent anionic group when n is 2 or X is a divalent anionic group when n is 1; n is 1 or 2.

In formula (IV), L and M can be as defined above for formula (I). Q can be as defined above for formula (I), preferably Q can be selected from —O—, —NR—, —CR₂— and —S—; Y can be either C or S; Z can e selected from —OR, —NR₂, —CR₃, —SR, —SiR₃, —PR₂, —H, and substituted or unsubstituted aryl groups, with the proviso that when Q is —NR— then Z can be selected from —OR, —NR₂, —SR, —SiR₃, —PR₂ and —H; R can be selected from a group containing carbon, silicon, nitrogen, oxygen, and/or phosphorus, preferably where R can be a hydrocarbon group containing from 1 to 20 carbon atoms, most preferably an alkyl, cycloalkyl, or an aryl group; n can be an integer from 1 to 4, preferably 1 or 2; X can be a univalent anionic group when n is 2 or X is a divalent anionic group when n is 1; preferably X can be a carbamate, carboxylate, or other heteroallyl moiety described by the Q, Y and Z combination

In another embodiment, the bulky ligand metallocene-type catalyst compounds can be heterocyclic ligand complexes where the bulky ligands, the ring(s) or ring system(s), include one or more heteroatoms or a combination thereof. Non-limiting examples of heteroatoms include a Group 13 to 16 element, preferably nitrogen, boron, sulfur, oxygen, aluminum, silicon, phosphorous and tin. Examples of these bulky ligand metallocene-type catalyst compounds are described in WO 96/33202, WO 96/34021, WO 97/17379 and WO 98/22486; EP Patent Application No. EP-A1-0 874 005; and U.S. Pat. Nos. 5,637,660, 5,539,124, 5,554,775, 5,756,611, 5,233,049, 5,744,417, and 5,856,258.

In another embodiment, the bulky ligand metallocene-type catalyst compounds can be those complexes known as transition metal catalysts based on bidentate ligands containing pyridine or quinoline moieties, such as those described in U.S. Pat. Nos. 6,103,357 and 6,103,620. In another embodiment, the bulky ligand metallocene-type catalyst compounds can include those described in PCT publications WO 99/01481 and WO 98/42664.

In one embodiment, the bulky ligand metallocene-type catalyst compound can be represented by the formula (V): ((Z)XAₜ(YJ))_{q}MQₙ, where M can be a metal selected from Group 3 to 13 or lanthanide and actinide series of the Periodic Table of Elements; Q can be bonded to M and each Q can be a monovalent, bivalent, or trivalent anion; X and Y can be bonded to M; one or more of X and Y are heteroatoms, preferably both X and Y can be heteroatoms; Y can be contained in a heterocyclic ring J, where J can include from 2 to 50 non-hydrogen atoms, preferably 2 to 30 carbon atoms; Z can be bonded to X, where Z can include 1 to 50 non-hydrogen atoms, preferably 1 to 50 carbon atoms, preferably Z can be a cyclic group containing 3 to 50 atoms, preferably 3 to 30 carbon atoms; t can be 0 or 1; when t is 1, A is a bridging group joined to at least one of X, Y or J, preferably X and J; q can be 1 or 2; n can be an integer from 1 to 4 depending on the oxidation state of M. In one embodiment, where X is oxygen or sulfur, then Z is optional. In another embodiment, where X is nitrogen or phosphorous, then Z is present. In an embodiment, Z is preferably an aryl group, more preferably a substituted aryl group.

It is also contemplated that in one embodiment, the bulky ligand metallocene-type catalyst can include their structural or optical or enantiomeric isomers (meso and racemic isomers, for example see U.S. Pat. No. 5,852,143, and mixtures thereof.

Exemplary metallocene catalysts and catalyst systems are described in U.S. Pat. Nos. 4,530,914, 4,871,705, 4,937,299, 5,017,714, 5,055,438, 5,096,867, 5,120,867, 5,124,418, 5,198,401, 5,210,352, 5,229,478, 5,264,405, 5,278,264, 5,278,119, 5,304,614, 5,324,800, 5,347,025, 5,350,723, 5,384,299, 5,391,790, 5,391,789, 5,399,636, 5,408,017, 5,491,207, 5,455,366, 5,534,473, 5,539,124, 5,554,775, 5,621,126, 5,684,098, 5,693,730, 5,698,634, 5,710,297, 5,712,354, 5,714,427, 5,714,555, 5,728,641, 5,728,839, 5,753,577, 5,767,209, 5,770,753, 5,770,664; EP-A-0 591 756, EP-A-0 520-732, EP-A-0 420 436, EP-B1 0 485 822, EP-B1 0 485 823, EP-A2-0 743 324, EP-B1 0 518 092; WO 91/04257, WO 92/00333, WO 93/08221, WO 93/08199, WO 94/01471, WO 96/20233, WO 97/15582, WO 97/19959, WO 97/46567, WO 98/01455, WO 98/06759, and WO 98/011144.

### Other Bulky Ligand Transition Metal Catalysts

Other bulky ligand transition metal catalyst compounds can include complexes of Ni²+ and Pd²+ described in the articles Johnson, et al., “New Pd(II)- and Ni(II)-Based Catalysts for Polymerization of Ethylene and a-Olefins”, J. Am. Chem. Soc. 1995, 117, pp. 6414-6415 and Johnson, et al., “Copolymerization of Ethylene and Propylene with Functionalized Vinyl Monomers by Palladium(II) Catalysts”, J. Am. Chem. Soc., 1996, 118, pp. 267-268, and PCT Publications WO 96/23010 and WO 99/02472 and U.S. Pat. Nos. 5,852,145, 5,866,663 and 5,880,241. These complexes can be either dialkyl ether adducts, or alkylated reaction products of the described dihalide complexes that can be activated to a cationic state by one or more activators. Also included as bulky ligand transition metal catalysts are those «-diimine based ligands of Group 8 to 10 metal compounds disclosed in PCT publications WO 96/23010 and WO 97/48735 and Gibson, et al., Chem. Comm., pp. 849-850 (1998).

Other bulky ligand transition metal catalysts can include those Group 5 and 6 metal imido complexes described in EP-A2-0 816 384 and U.S. Pat. No. 5,851,945. In addition, bulky ligand transition metal catalysts include bridged bis(arylamido) Group 4 compounds described by D. H. McConville, et al., Organometallics 1995, 14, pp. 5478-5480. Other bulky ligand transition metal catalysts are described as bis(hydroxy aromatic nitrogen ligands) in U.S. Pat. No. 5,852,146. Other transition metal catalysts containing one or more Group 15 atoms include those described in WO 98/46651.

### Conventional-Type Catalysts

Conventional-type catalysts include Ziegler-Natta catalysts and Phillips-type chromium catalyst that are well known in the art. Examples of conventional-type transition metal catalysts include those disclosed in U.S. Pat. Nos. 4,115,639, 4,077,904 4,482,687, 4,564,605, 4,721,763, 4,879,359 and 4,960,741. The conventional-type transition metal catalyst compounds can include, but are not limited to, transition metal compounds from Groups 3 to 10 of the Periodic Table of the Elements. The conventional-type transition metal catalyst compounds disclosed herein can be activated with one or more of the conventional cocatalysts described below.

In some embodiments, the conventional-type transition metal catalysts can be represented by the chemical formula (VI): MRₓ, where M can be a metal from Groups 3 to 10, preferably Group 4, more preferably titanium; R can be a halogen or a hydrocarbyloxy group; and x can be the valence of the metal M. In some embodiments. R can be an alkoxy, a phenoxy, bromide, chloride, or fluoride. In some embodiments, when M is titanium, the conventional-type transition metal catalyst can be or can include, but is not limited to, TiCl₄, TiBr₄, Ti(OC₂H₅)₃Cl, Ti(OC₂H₅)Cl₃, Ti(OC₄H₉)₃Cl, Ti(OC₃H₇)₂Cl₂, Ti(OC₂H₅)₂Br₂, TiCl₃·⅓AlCl₃, and Ti(OC₁₂H₂₅)Cl₃.

In some embodiments, conventional-type transition metal catalysts based on magnesium/titanium electron-donor complexes can include those described in, for example, U.S. Pat. Nos. 4,302,565 and 4,302,566. The MgTiCl₆ (ethyl acetate)₄ derivative is one such example. British Patent No. GB2105355B describes various conventional-type vanadium catalyst compounds. Non-limiting examples of conventional-type vanadium catalyst compounds include vanadyl trihalide, alkoxy halides and alkoxides such as VOCl₃, VOCl₂(OBu), where Bu=butyl, and VO(OC₂H₅)₃; vanadium tetra-halide and vanadium alkoxy halides such as VCl₄ and VCl₃(OBu), where Bu=butyl; vanadium and vanadyl acetyl acetonates and chloroacetyl acetonates such as V(AcAc)₃ and VOCl₂(AcAc), where (AcAc) is an acetyl acetonate. Examples of conventional-type vanadium catalyst compounds also can include VOCl₃, VCl₄, and formula (XII): VOCl₂—OR, where R is a hydrocarbon radical, preferably a C₁ to C₁₀ aliphatic or aromatic hydrocarbon radical such as ethyl, propyl, isopropyl, n-butyl, isobutyl, tert-butyl, hexyl, cyclohexyl, phenyl, napthyl, etc., and vanadium acetyl acetonates.

Conventional-type chromium catalyst compounds, often referred to as Phillips-type catalysts, can include CrO₃, chromocene, silyl chromate, chromyl chloride (CrO₂Cl₂), chromium-2-ethyl-hexanoate, chromium acetylacetonate (Cr(AcAc)₃), and the like. Non-limiting examples of Phillips-type catalyst can include those disclosed in U.S. Pat. Nos. 3,242,099 and 3,231,550.

Other conventional-type transition metal catalyst compounds and catalyst systems can include those disclosed in U.S. Pat. Nos. 4,124,532; 4,302,565; 4,302,566; and 5,763,723; and published EP0416815A2 and EP0420436A1. In some embodiments, the conventional-type transition metal catalyst can have the general formula (VIII): M′₁M″X₂ₜYᵤE, where M′ is Mg, Mn and/or Ca; t is a number from 0.5 to 2; M″ is a transition metal Ti, V, and/or Zr; X is a halogen, preferably C₁, Br or I; Y can be the same or different and is halogen, alone or in combination with oxygen, —NR₂, —OR, —SR, —COOR, or —OSOOR, where R is a hydrocarbyl radical, in particular an alkyl, aryl, cycloalkyl or arylalkyl radical, acetylacetonate anion in an amount that satisfies the valence state of M; u is a number from 0.5 to 20; E is an electron donor compound selected from the following classes of compounds: (a) esters of organic carboxylic acids; (b) alcohols; (c) ethers; (d) amines; (e) esters of carbonic acid; (f) nitriles; (g) phosphoramides, (h) esters of phosphoric and phosphorus acid, and (j) phosphorus oxy-chloride. Examples of complexes satisfying the above formula include, but are not limited to, MgTiCl₅·2CH₃COOC₂H₅, Mg₃Ti₂Cl₁₂7CH₃COOC₂H₅, MgTiCl₅·6C₂H₅OH, MgTiCl₅·100CH₃OH, MgTiCl₅ tetrahydrofuran, MgTi₂Cl₁₂7C₆H₅CN, MgTi₂ Cl₁₂6C₆H₅COOC₂H₅, MgTiCl₆2CH₃COOC₂H₅, MgTiCl₆6C₅H₅N, MgTiCl₅(OCH₃)₂CH₃COOC₂H₅, MgTiCl₅N(C₆H₅)₂3CH₃COOC₂H₅, MgTiBr₂Cl₄2(C₂H₅)O, MnTiCl₅4C₂H₅OH, Mg₃V₂Cl₁₂·7CH₃COOC₂H₅, MgZrCl₆4tetrahydrofuran. Other catalysts can include cationic catalysts such as AlCl₃, and other cobalt and iron catalysts well known in the art.

### Conventional-Type Cocatalysts and Other Components

Conventional-type cocatalyst compounds for the above conventional-type transition metal catalyst compounds can be represented by the formula (IX): M³M⁴ᵥX²_{c}R³_{b-c}, where M³ can be a metal from Group 1, 2, 12 or 13 of the Periodic Table of Elements; M⁴ can be a metal from Group IA of the Periodic Table of Elements; v can be a number from 0 to 1; each X² can be any halogen; c can be a number from 0 to 3; each R³ can be a monovalent hydrocarbon radical or hydrogen; b can be a number from 1 to 4; and where b minus c can be at least 1. Other conventional-type organometallic cocatalyst compounds for the above conventional-type transition metal catalysts have the formula (X): M³R³ₖ, where M³ can be a Group 1, 2, 12 or 13 metal, such as lithium, sodium, beryllium, barium, zinc, cadmium, boron, aluminum, and gallium; k can be 1, 2 or 3 depending on the valency of M³ which valency in turn normally depends on the particular Group to which M³ belongs; and each R³ can be any monovalent hydrocarbon radical.

Examples of conventional-type organometallic cocatalyst compounds of Group 1, 2, 12, and 13 useful with the conventional-type catalyst compounds described above include, but are not limited to, methyllithium, butyllithium, dihexylmercury, butylmagnesium, diethylcadmium, benzylpotassium, diethylzinc, tri-n-butylaluminum, diisobutyl ethylboron, diethylcadmium, di-n-butylzinc and tri-n-amylboron, and, in particular, the aluminum alkyls, such as tri-hexyl-aluminum, triethylaluminum, trimethylaluminum, and tri-isobutylaluminum. Other conventional-type cocatalyst compounds can include mono-organohalides and hydrides of Group 1 and 12 metals, and mono- or di-organohalides and hydrides of Group 13 metals. Non-limiting examples of such conventional-type cocatalyst compounds can include di-isobutylaluminum bromide, isobutylboron dichloride, methyl magnesium chloride, ethylberyllium chloride, ethylcalcium bromide, di-isobutylaluminum hydride, methylcadmium hydride, diethylboron hydride, hexylberyllium hydride, dipropylboron hydride, octylmagnesium hydride, butylzinc hydride, dichloroboron hydride, di-bromo-aluminum hydride and bromocadmium hydride. Conventional-type organometallic cocatalyst compounds are known to those in the art and a more complete discussion of these compounds can be found in U.S. Pat. Nos. 3,221,002 and 5,093,415.

### Aluminum-Containing Compounds

In some embodiments, the first and second aluminum-containing compounds can be or can include, but are not limited to, a compound represented by the formula (XI): AlR₍₃₋ₐ₎Xₐ, where R can be a branched or straight chain alkyl, cycloalkyl, heterocycloalkyl, aryl, or a hydride radical having from 1 to 30 carbon atoms, X can be a halogen, and a is 0, 1, or 2. In some embodiments, the aluminum-containing compound can be or can include, but is not limited to, tri-hexyl-aluminum, triethylaluminum, trimethylaluminum, tri-isobutylaluminum, di-isobutylaluminum bromide, di-isobutylaluminum hydride, or any mixture thereof.

### Anti-Static Agents

In some embodiments, the anti-static agent can be a chemical composition that, when introduced into a fluidized bed polymerization reactor, can influence or drive the static charge (negatively, positively, or to zero) in the fluidized bed. The specific anti-static agent used can depend, at least in part, on the nature of the static charge, and the choice of static control agent can vary depending, at least in part, on the polymer being produced and/or the single site catalyst compounds being used.

In some embodiments, the anti-static agent can include one or more extracted metal carboxylate salts. As used herein, the term “metal carboxylate salt” refers to any mono-, di-, or tri-carboxylic acid salt with a metal portion from the Periodic Table of Elements. Without wishing to be bound by theory, it is believed that extraction of the metal carboxylate salt reduces or potentially even eliminates free carboxylic acids or derivatives thereof, which usually residually remain after synthesis of the metal carboxylate salt. It is believed that reduced catalyst productivity and resin bulk densities that result from the use of metal carboxylates salts with metallocene catalysts can be due, at least in part, to the fraction of free carboxylic acid or Group 1 or Group 2 salts thereof present in the metal carboxylate salt.

In some embodiments, the extracted metal carboxylate salt can be substantially free of free carboxylic acids. As used herein, the term “substantially free of free carboxylic acids” refers to an extracted metal carboxylate salt which does not show a melting point that corresponds to the free acid or a Group 1 or Group 2 salt thereof in a differential scanning calorimetry (DSC) analysis thereof. The extracted metal carboxylate salt can have less than or equal to about 1 wt % of total free acid, or less than or equal to about 0.5 wt %, or less than or equal to about 0.1 wt % of total free acid, based on the total weight of the extracted metal carboxylate salt as determined chromatographically.

The extracted metal carboxylate salt can be produced by extracting a metal carboxylate salt with an organic solvent having a dielectric constant of greater than or equal to 3 at 25° C. In some embodiments, preferred organic solvents can have a dielectric constant at 25° C. of greater than or equal to 3.5, greater than or equal to 5, greater than or equal to 7, greater than or equal to 10, greater than or equal to 12, greater than or equal to 15, greater than or equal to 17, or greater than or equal to 20. The organic solvent can be a polar solvent that can improve extraction of the polar compounds including the free acids present in the crude metal carboxylate salt. In some embodiments, the organic solvent can be or can include, but is not limited to, C₁-C₁₀ alcohols, C₁-C₁₀ ketones, C₁-C₁₀ esters, C₁-C₁₀ ethers, C₁-C₁₀ alkyl halides, C₁-C₁₀ alkylonitriles, C₁-C₁₀ dialkyl sulfoxides, or any mixture thereof. In another embodiment, the organic solvent can be selected from methanol, ethanol, propanol, isopropanol, butanol, acetone, methyl-ethyl ketone, methyl acetate, ethyl acetate, methyl propionate, a butyrate ester, dimethyl ether, diethyl ether, 1,4-dioxane, tetrahydrofuran, chloroform, dichloromethane, acetonitrile, dimethyl sulfoxide, or any mixture thereof.

Non-limiting examples of metal carboxylic salts which can be used as the precursor for the extracted metal carboxylate salts can be or can include, but are not limited to, saturated, unsaturated, aliphatic, and/or aromatic or saturated cyclic carboxylic acid salts. Examples of the carboxylate ligand can include, but are not limited to, acetate, propionate, butyrate, valerate, pivalate, caproate, isobuytlacetate, t-butyl-acetate, caprylate, heptanate, pelargonate, undecanoate, oleate, octoate, palmitate, myristate, margarate, stearate, arachate and tercosanoate. In some embodiments, the metal portion can be or can include, but is not limited to, a metal selected from Al, Mg, Ca, Sr, Sn, Ti, V, Ba, Zn, Cd, Hg, Mn, Fe, Co, Ni, Pd, Li and Na.

In some embodiments, the metal carboxylate salt can be represented by the following general formula (XII): M(Q)x(OOCR)y, where M can be a metal from Group 3 to 16 and the Lanthanide and Actinide series, alternatively from Groups 8 to 13, alternatively from Group 13 with aluminum being one specific example; Q can be a halogen, hydrogen, a hydroxy or hydroxide, an alkyl, an alkoxy, an aryloxy, a siloxy, a silane, or a sulfonate group, R can be a hydrocarbyl radical having from 1 to 100 carbon atoms; x can be an integer from 0 to 3, y can be an integer from 1 to 4, and the sum of x and y can be equal to the valence of the metal. R in the formula can be the same or different. Non-limiting examples of R include hydrocarbyl radicals having 2 to 100 carbon atoms that include alkyl, aryl, aromatic, aliphatic, cyclic, saturated or unsaturated hydrocarbyl radicals. In some embodiments, R can be a hydrocarbyl radical having greater than or equal to 8 carbon atoms, or greater than or equal to 12 carbon atoms, or greater than 14 carbon atoms. In other embodiments, R can include a hydrocarbyl radical having from 17 to 90 carbon atoms, or from 17 to 72 carbon atoms, or from 17 to 54 carbon atoms. In other embodiments, R can include 6 to 30 carbon atoms, or 8 to 24 carbon atoms, or 16 to 18 carbon atoms (e.g., plamityl and stearyl). In some embodiments, Q can include one or more, same or different, hydrocarbon containing groups such as alkyl, cycloalkyl, aryl, alkenyl, arylalkyl, arylalkenyl or alkylaryl, alkylsilane, arylsilane, alkylamine, arylamine, alkyl phosphide, alkoxy, having from 1 to 30 carbon atoms. The hydrocarbon containing group can be linear, branched, or even substituted. Q can also be an inorganic group such as a halide, sulfate or phosphate.

In some embodiments, the metal carboxylate salt can include aluminum carboxylates such as aluminum mono-, di-, and tri-stearates, aluminum octoates, oleates and cyclohexylbutyrates. For example, the metal carboxylate salt can be or can include (CH₃(CH₂)₁₆COO)₃Al (an aluminum tri-stearate), (CH₃(CH₂)₁₆COO)₂—Al—OH (an aluminum di-stearate), and/or an CH₃(CH₂)₁₆COO-Al(OH)₂ (an aluminum mono-stearate). Other examples of metal carboxylate salts include titanium stearates, tin stearates, calcium stearates, zinc stearates, boron stearate, and strontium stearates.

The amount of the extracted metal carboxylate salt added to the reactor system can depend, at least in part, on the catalyst used, as well as reactor pre-conditioning (such as reactor wall coatings to control static buildup) and other factors known to those skilled in the art, such as the conditions, temperature and pressure of the reactor, the type of mixing apparatus, the quantities of the components to be combined, and even the mechanism for introducing the catalyst/continuity additive combination into the reactor. In some embodiments, the ratio of the amount of the extracted metal carboxylate salt to the amount of polymer produced in the reactor at a given time can be between about 0.5 ppm, about 1 ppm, about 5 ppm, or about 10 ppm to about 50 ppm, about 400 ppm, about 750 ppm, or about 1,000 ppm.

The extracted metal carboxylate salt can be used as a part of the catalyst composition introduced into the polymerization reactor and/or can be introduced directly into the reactor independently of the catalyst composition. For example, the extracted metal carboxylate salt and the catalyst composition can be fed to the reactor separately. The extracted metal carboxylate salt can be fed to the polymerization reactor as a solution and/or as a slurry. For example, the extracted metal carboxylate salt can be initially admixed or combined with mineral oil, forming a slurry that can be fed to the reactor. In some embodiments, the extracted metal carboxylate salt and the catalyst composition can be co-injected into the reactor. For example, the catalyst can be unsupported in a liquid form, such as described in U.S. Pat. Nos. 5,317,036 and 5,693,727 and European Patent Application Publication No. EP0593083A. In some embodiments, the catalyst in liquid form can be e fed with the extracted metal carboxylate salt to the polymerization reactor using the injection methods described, for example, in WO 97/46599.

In some embodiments, a catalyst compound, e.g., the metallocene catalyst, can be contacted with the extracted metal carboxylate salt to make a catalyst composition. Contacting the catalyst and the extracted metal carboxylate salt can include combining, blending, mixing, or the like. In some embodiments, the extracted metal carboxylate salt can be present in the catalyst composition in an amount of about 0.1 wt %, about 0.5 wt %, about 1 wt %, about 2 wt %, about 3 wt %, about 4 wt %, about 5 wt %, about 6 wt %, about 7 wt %, about 8 wt %, about 9 wt %, or about 10 wt % to about 12 wt %, about 14 wt %, about 16 wt %, about 18 wt %, about 20 wt %, about 22 wt %, about 23 wt %, or about 25 wt %, based on the total weight of the catalyst composition.

In some embodiments, a supported metallocene catalyst can be tumbled with the extracted metal carboxylate salt for a period of time such that a substantial portion of the supported catalyst can be mixed and/or substantially contacted with the extracted metal carboxylate salt. The extracted metal carboxylate salt can also be pre-mixed with a cocatalyst or activator such as, an organo metallic compound, such as, methylalumoxane or modified methylalumoxane, before being introduced into the polymerization reactor.

In some embodiments, the catalyst composition can be supported and can be substantially dried, preformed, and/or free flowing. In this embodiment, the preformed supported catalyst composition can be contacted with the extracted metal carboxylate salt. In some embodiments, the extracted metal carboxylate salt can be in solution, emulsion, or slurry. In some embodiments, the extracted metal carboxylate salt can be in a solid form such as free flowing powder. In yet another embodiment, the extracted metal carboxylate salt can be contacted with a supported catalyst composition, for example, a supported metallocene catalyst composition, in a rotary mixer, such as a tumble mixer, under a nitrogen atmosphere or in a fluidized bed mixing process. In some embodiments, a metallocene catalyst can be contacted with a support to form a supported metallocene catalyst and an activator can be contacted with a separate support to form a supported activator. The extracted metal carboxylate salt can be mixed with the supported catalyst compound and/or the supported activator, in any order, separately mixed, simultaneously mixed, or mixed with only one of the supported catalyst, or, for example, the supported activator prior to mixing the separately supported catalyst and activator. Mixing and other contacting techniques can include shaking, stirring, tumbling, and rolling, and the like. Another technique can include the use of fluidization, for example, in a fluid bed reactor vessel where circulated gases can provide the contacting.

In other embodiments, the anti-static can be or can include, but is not limited to, fatty acid amines, amide-hydrocarbon or ethoxylated-amine compounds such as described as “surface modifiers” in WO 96/11961; carboxylate compounds such as aryl-carboxylates and long chain hydrocarbon carboxylates, fatty acid-metal complexes; alcohols, ethers, sulfate compounds, metal oxides and other compounds known in the art. Some specific examples of continuity additives can be or can include, but are not limited to, 1,2-diether organic compounds, magnesium oxide, ARMOSTAT 310, ATMER 163, ATMER AS-990, and other glycerol esters, ethoxylated amines (e.g., N,N-bis(2-hydroxyethyl)octadecylamine), alkyl sulfonates, and alkoxylated fatty acid esters; STADIS 450 and 425, KEROSTAT CE 4009 and KEROSTAT CE 5009, chromium N-oleylanthranilate salts, calcium salts of a Medialan acid and di-tert-butylphenol; POLYFLO 130, TOLAD 511 (a-olefin-acrylonitrile copolymer and polymeric polyamine), EDENOL D32, sorbitan-monooleate, glycerol monostearate, methyl toluate, dimethyl maleate, dimethyl fumarate, triethylamine, 3,3-diphenyl-3-(imidazol-1-yl)-propin, and like compounds. In some embodiments, the additional continuity additive is a metal carboxylate salt as described, optionally, with other compounds as described herein.

Any of the aforementioned additional continuity additives can be employed either alone or in combination as an additional continuity additive. For example, the extracted metal carboxylate salt can be combined with an amine containing control agent (e.g., an extracted carboxylate metal salt with any family member belonging to the KEMAMINE (available from Chemtura Corporation) or ATMER (available from ICI Americas Inc.) family of products). For example, the extracted metal carboxylate salt can be combined with antistatic agents such as fatty amines, such as, KEMAMINE AS 990/2 zinc additive, a blend of ethoxylated stearyl amine and zinc stearate, or KEMAMINE AS 990/3, a blend of ethoxylated stearyl amine, zinc stearate and octadecyl-3,5-di-tert-butyl-4-hydroxyhydrocinnamate.

### Supports

As used herein, the terms “support” and “carrier” are used interchangeably and refer to any material, including a porous material, such as talc, inorganic oxides, and inorganic chlorides. The metallocene catalyst and/or the Ziegler-Natta catalyst can be supported. In some embodiments, the metallocene catalyst and/or the Ziegler-Natta catalyst can be supported on a support together with an activator, cocatalyst, or other compound(s). In some embodiments, the metallocene catalyst and/or the Ziegler-Natta catalyst and/or the activator and/or cocatalyst can be used in an unsupported form, or can be deposited on a support different from the catalyst(s), or any combination thereof. This can be accomplished by any technique commonly used in the art. There are various other suitable methods for supporting the catalyst. For example, the catalyst can contain a polymer bound ligand. The support, if used with the catalyst, can be functionalized.

The support can be or can include one or more inorganic oxides, for example, of Group 2, 3, 4, 5, 13, or 14 elements. The inorganic oxide can include, but is not limited to silica, alumina, titania, zirconia, boria, zinc oxide, magnesia, or any combination thereof. Illustrative combinations of inorganic oxides can include, but are not limited to, alumina-silica, silica-titania, alumina-silica-titania, alumina-zirconia, alumina-titania, and the like. The support can be or include silica, alumina, or a combination thereof. In one embodiment described herein, the support is silica.

Suitable commercially available silica supports can include, but are not limited to, ES757, ES70, and ES70W available from PQ Corporation. Suitable commercially available silica-alumina supports can include, but are not limited to, SIRALR 1. SIRALR 5, SIRALR 10, SIRALR 20, SIRALR 28M, SIRALR 30, and SIRALR 40, available from SASOLR. Generally, catalyst supports that include silica gels with activators, such as methylaluminoxanes (MAOs), can be used in the trim systems described, since these supports may function better for co-supporting solution carried catalysts.

In some embodiments, the support can include a support material treated with an electron-withdrawing anion. In some embodiments, the support material can be silica, alumina, silica-alumina, silica-zirconia, alumina-zirconia, aluminum phosphate, heteropolytungstates, titania, magnesia, boria, zinc oxide, mixed oxides thereof, or mixtures thereof; and the electron-withdrawing anion can be selected from fluoride, chloride, bromide, phosphate, triflate, bisulfate, sulfate, or any combination thereof.

The electron-withdrawing component that can be used to treat the support material can be any component that increases the Lewis or Brønsted acidity of the support material upon treatment (as compared to the support material that is not treated with at least one electron-withdrawing anion). In at least one embodiment, the electron-withdrawing component can be an electron-withdrawing anion derived from a salt, an acid, or other compound, such as a volatile organic compound, that serves as a source or precursor for that anion. Electron-withdrawing anions can include, but are not limited to, sulfate, bisulfate, fluoride, chloride, bromide, iodide, fluorosulfate, fluoroborate, phosphate, fluorophosphate, trifluoroacetate, triflate, fluorozirconate, fluorotitanate, phospho-tungstate, or mixtures thereof, or combinations thereof. An electron-withdrawing anion can include fluoride, chloride, bromide, phosphate, triflate, bisulfate, or sulfate, or any combination thereof. In at least one embodiment, the electron-withdrawing anion can be sulfate, bisulfate, fluoride, chloride, bromide, iodide, fluorosulfate, fluoroborate, phosphate, fluorophosphate, trifluoroacetate, triflate, fluorozirconate, fluorotitanate, or combinations thereof.

Thus, in some embodiments, the support material can be one or more of fluorided alumina, chlorided alumina, bromided alumina, sulfated alumina, fluorided silica-alumina, chlorided silica-alumina, bromided silica-alumina, sulfated silica-alumina, fluorided silica-zirconia, chlorided silica-zirconia, bromided silica-zirconia, sulfated silica-zirconia, fluorided silica-titania, fluorided silica-coated alumina, sulfated silica-coated alumina, phosphated silica-coated alumina, or combinations thereof. In at least one embodiment, the activator-support can be, or can include, fluorided alumina, sulfated alumina, fluorided silica-alumina, sulfated silica-alumina, fluorided silica-coated alumina, sulfated silica-coated alumina, phosphated silica-coated alumina, or combinations thereof. In another embodiment, the support material can include alumina treated with hexafluorotitanic acid, silica-coated alumina treated with hexafluorotitanic acid, silica-alumina treated with hexafluorozirconic acid, silica-alumina treated with trifluoroacetic acid, fluorided boria-alumina, silica treated with tetrafluoroboric acid, alumina treated with tetrafluoroboric acid, alumina treated with hexafluorophosphoric acid, or combinations thereof. Further, any of these activator-supports optionally can be treated with a metal ion.

Nonlimiting examples of cations suitable for use in the salt of the electron-withdrawing anion include ammonium, trialkyl ammonium, tetraalkyl ammonium, tetraalkyl phosphonium, H+. [H(OEt₂)₂]+, or combinations thereof. Further, combinations of one or more different electron-withdrawing anions, in varying proportions, can be used to tailor the specific acidity of the support material to a desired level. Combinations of electron-withdrawing components can be contacted with the support material simultaneously or individually, and in any order that provides a desired chemically-treated support material acidity. For example, in at least one embodiment, two or more electron-withdrawing anion source compounds can be contacted with the support material in two or more separate contacting steps.

In at least one embodiment, an example of a process by which a chemically-treated support material can be prepared can be as follows: a selected support material, or combination of support materials, can be contacted with a first electron-withdrawing anion source compound to form a first mixture; such first mixture can be calcined and then contacted with a second electron-withdrawing anion source compound to form a second mixture; the second mixture can then be calcined to form a treated support material. In such a process, the first and second electron-withdrawing anion source compounds can be either the same or different compounds.

The process by which the support material can be contacted with the electron-withdrawing component, typically a salt or an acid of an electron-withdrawing anion, can include gelling, co-gelling, impregnation of one compound onto another, or combinations thereof. Following a contacting method, the contacted mixture of the support material, electron-withdrawing anion, and optional metal ion, can be calcined. According to another embodiment, the support material can be treated by a process that can include: (i) contacting a support material with a first electron-withdrawing anion source compound to form a first mixture; (ii) calcining the first mixture to produce a calcined first mixture; (iii) contacting the calcined first mixture with a second electron-withdrawing anion source compound to form a second mixture; and (iv) calcining the second mixture to form the treated support material.

### Activators

As used herein, the term “activator” refers to any compound or combination of compounds, supported or unsupported, which can activate a single site catalyst compound or component, e.g., the metallocene catalyst. Such as by creating a cationic species of the catalyst component. For example, this can include the abstraction of at least one leaving group (the ‘X’ group in the single site catalyst compounds described herein) from the metal center of the single site catalyst compound/component. The activator may also be referred to as a “co-catalyst”. For example, the activator can include a Lewis acid or a non-coordinating ionic activator or ionizing activator, or any other compound including Lewis bases, aluminum alkyls, and/or conventional-type co-catalysts. In addition to methylaluminoxane (“MAO”) and modified methylaluminoxane (“MMAO”) mentioned above, illustrative activators can include, but are not limited to, aluminoxane or modified aluminoxane, and/or ionizing compounds, neutral or ionic, such as tri (n-butyl)ammonium tetrakis(pentafluorophenyl) boron, a trisperfluorophenyl boron metalloid precursor, a trisperfluoronaphthyl boron metalloid precursor, or any combinations thereof.

Aluminoxanes can be described as oligomeric aluminum compounds having Al(R)—O— subunits, where R is an alkyl group. Examples of aluminoxanes include, but are not limited to, methylaluminoxane (“MAO”), modified methylaluminoxane (“MMAO”), ethylaluminoxane, isobutylaluminoxane, or a combination thereof. Aluminoxanes can be produced by the hydrolysis of the respective trialkylaluminum compound. MMAO can be produced by the hydrolysis of trimethylaluminum and a higher trialkylaluminum, such as triisobutylaluminum. MMAOs are generally more soluble in aliphatic solvents and more stable during storage. There are a variety of methods for preparing aluminoxane and modified aluminoxanes.

### Examples

The foregoing discussion can be further described with reference to the following non-limiting examples.

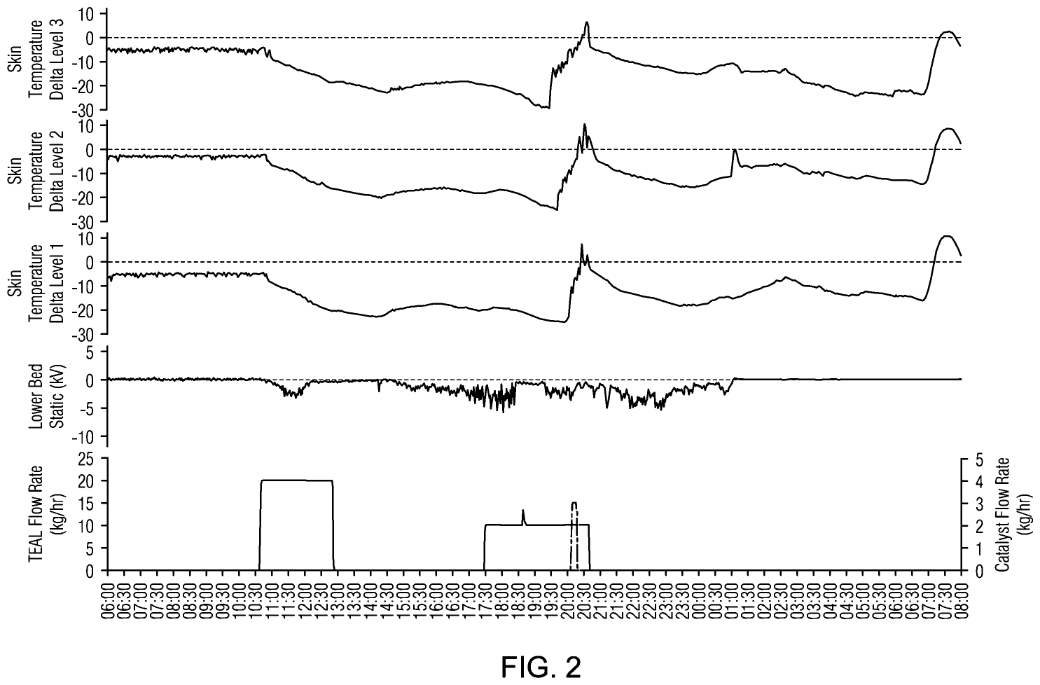

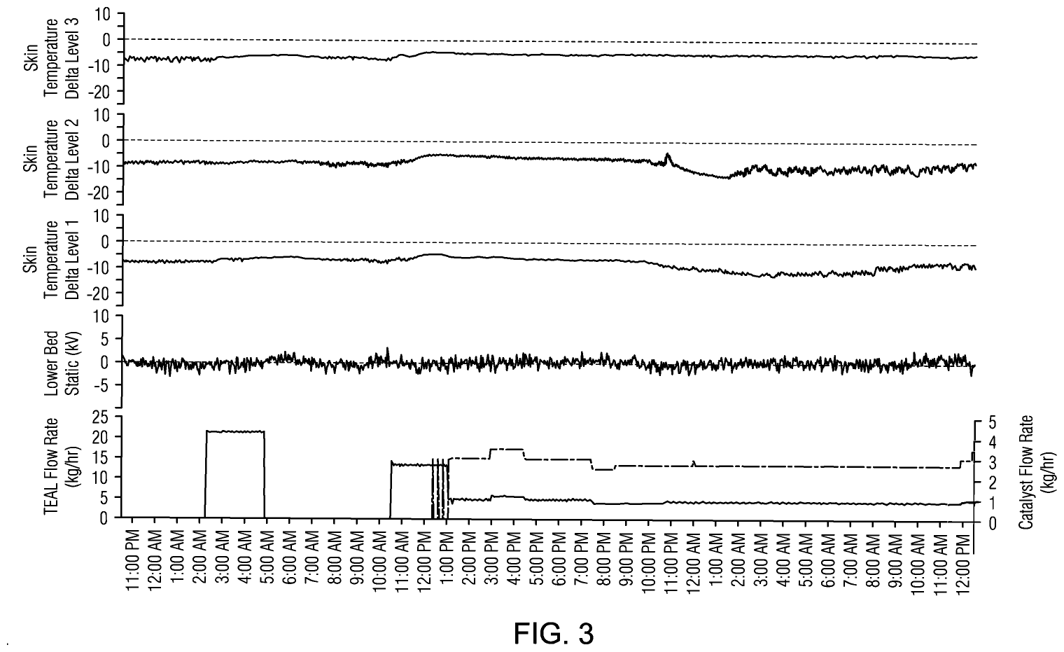

FIGS. 2 and 3 show polymerization reactor data for a comparative start-up process and an inventive start-up process, respectively, upon switching from a metallocene catalyst to a Ziegler-Natta catalyst. More particularly, in both polymerization start-ups, the previous polymerizations were carried out in the presence of a metallocene catalyst and the data shown for the start-up is with regard to re-starting the polymerization reactor with a Ziegler-Natta catalyst.

In FIG. 2, the bottom most row shows a flow rate of triethylaluminum (solid line, “-”) and a flow rate of the Ziegler-Natta catalyst (long and short dashed line, “- -”). The first injection of triethylaluminum was during drying of the seedbed to neutralize any moisture trapped in the seedbed. The second injection of triethylaluminum was during injection of all the feeds into the reactor (typically referred to as concentration build) to achieve the right conditions to start polymerization. There was a short introduction of Ziegler-Natta catalyst as shown by a short peak of catalyst flow.

The second row from the bottom in FIG. 2 shows the measured bed static at a lowest measured position within the reactor. Changes in this static measurement can be a reliable indication of bed stability; thus, while the absolute measurement values themselves are not important, changes from baseline are. In particular, wide fluctuations or changes from the base line value during introduction of the triethylalumium are not good indicators. In this example it can be seen that the static value started to trend downward soon after the first alkyl injection and then again trended downward during the concentration build. The downward trends mean that an unstable startup is likely after injection of the Ziegler-Nata catalyst, which can lead to skin temperature indications that exceed a controlled reaction temperature, and, thus, result in sheeting and shutdown of the reactor.

The top 3 rows in FIG. 2 show the behavior of temperature sensors (called skin temperature indicators or “skin Tis”) at various elevations along the vertical wall of the reactor before and after introduction of the Ziegler-Natta catalyst. The numerical values shown are the differences between a skin temperature indicator reading and bed control temperature. A positive value implies that the value of the skin temperature indicator is higher than the control temperature, which implies sheeting and likely leading to shutdown of the reactor. In this comparative example it can be seen that the introduction of the Ziegler-Natta catalyst caused the skin temperature indicators to reflect a cold value that indicated unstable fluidized bed conditions. The skin temperature indicators at all three levels ultimately became hotter than the control temperature, which led to sheeting and forced the reactor to be shut down.

In FIG. 3, each row corresponds to the same data as in FIG. 2. As can be seen, the bottom most row shows the flow rate of the triethylaluminum (solid line, “-”) and a flow rate of the Ziegler-Natta catalyst (one long and three short dashed line, “- - - -”). The first injection of triethylaluminum was during drying of the seed bed to neutralize any moisture trapped in the seed bed. The second injection of the triethylaluminum was during injection of all the feeds into the reactor (typically referred to as concentration build) to achieve the right conditions to start polymerization and was continued as there was no reactor shutdown involved. As planned, there were three short injections of Ziegler-Natta catalyst, shown by the three short peaks of catalyst flow before maintaining a constant flow of the Ziegler-Natta catalyst.

The second row from the bottom in FIG. 3 shows the measured bed static at a lowest measured position within the reactor, noting again that the differences from baseline (not the absolute values) are important. In this inventive process it can be seen that the lower bed static remained stable during introduction of the triethylaluminum, which is a sign of a stable fluidized bed that has a high probability of a good start-up.

The top 3 rows in FIG. 3 show the behavior of temperature indicators at various levels from the fluidized bed along the vertical wall of the reactor before and after introduction of the Ziegler-Natta catalyst into the polymerization reactor. In this inventive example it can be seen that after introduction of the Ziegler-Natta catalyst, the skin temperature indicators did not exceed the control temperature and there was no sheeting or any instability in the fluidized bed. Indeed, the start-up after transitioning from a metallocene catalyst to the Ziegler-Natta catalyst was smooth.

The difference between the comparative start-up and the inventive start-up was as follows. In the inventive startup, after stopping polymerization in the presence of the metallocene catalyst and removing the polymer/metallocene catalyst bed from the reactor, triethylaluminum (TEAL) was introduced into the reactor to neutralize residual antistatic agent that remained inside the reactor before introducing the new seedbed. It was discovered that this is a critical step to help ensure a good reactor restart when transitioning from a metallocene catalyst to a Zeigler-Natta catalyst. In the comparative startup, the introduction of triethylaluminum to neutralize residual antistatic agent was not used after the polymer/metallocene catalyst bed was removed from the reactor and before introducing the new seedbed. As such, during drying of the new seedbed produced with the Ziegler-Natta catalyst in the comparative example via the addition of the triethylaluminum and during startup of polymerization with the Ziegler-Natta catalyst, the byproducts of the triethylaluminum and residual antistatic agent were believed to cause the instability that led to fouling and shutdown of the reactor. In contrast, during the inventive example, the reaction between triethylaluminum and residual anti-static agent occurred well before drying of the new seedbed and the startup of polymerization with the Ziegler-Natta catalyst and, as such, did not really have any significant influence when the Ziegler-Natta polymerization started within the reactor.

### Listing of Embodiments

This disclosure may further include the following non-limiting embodiments.

A1. A process for transitioning from a metallocene catalyst to a Ziegler-Natta catalyst in a gas phase polymerization reactor, comprising: introducing a first olefin, an anti-static agent, a first carrier gas, and a plurality of metallocene catalyst particles into the reactor under conditions effective to maintain the metallocene catalyst particles in a fluidized state and to polymerize the first olefin in the presence of the metallocene catalyst particles to produce a first polymer product; stopping introduction of the metallocene catalyst particles and the anti-static agent into the reactor; introducing a kill agent into the reactor to stop polymerization of the first olefin within the reactor; stopping introducing of the first olefin into the reactor; removing a first portion of the first olefin from the reactor; removing the first polymer product, the metallocene catalyst particles, and the anti-static agent from the reactor; removing a second portion of the first olefin within the reactor such that the reactor contains ≤1,000 ppmv of the first olefin; introducing a first aluminum-containing compound into the reactor after the concentration of the first olefin is reduced to ≤1,000 ppmv, wherein the first aluminum-containing compound reacts with at least a portion of any residual anti-static agent that remains within the reactor to produce a first reaction product comprising ethane (or another alkane, e.g., propane, butane, hexane) and at least one additional product; removing at least a portion of the ethane (or alkane) in the first reaction product from the reactor; introducing water into the reactor, wherein the water reacts with at least a portion of any residual first aluminum-containing compound remaining within the reactor to produce a second reaction product comprising ethane (or another alkane, e.g., propane, butane, hexane) and a first alkylaluminum hydroxide; removing at least a portion of the ethane (or alkane) in the second reaction product from the reactor; introducing a seedbed produced with a Ziegler-Natta catalyst into the reactor; introducing a second carrier gas into the reactor and venting the reactor to dry the seed bed to a water concentration of ≤20 ppmv; introducing a second aluminum-containing compound into the reactor, wherein the second aluminum-containing compound reacts with at least a portion of any residual water within the reactor to produce a third reaction product comprising ethane (or another alkane, e.g., propane, butane, hexane) and a second alkylaluminum hydroxide; removing at least a portion of the ethane (or alkane) in the third reaction product from the reactor; introducing a second olefin into the reactor; and introducing a plurality of Ziegler-Natta catalyst particles and a third carrier gas into the reactor under conditions effective to maintain the Ziegler-Natta catalyst particles in a fluidized state and to polymerize the second olefin in the presence of the Ziegler-Natta catalyst particles to produce a second polymer product.

A2. The process of A1, wherein the anti-static agent is introduced into the reactor in the form of a mixture comprising the anti-static agent and a mineral oil, wherein the mineral oil at least partially coats the anti-static agent, and wherein after removing the second portion of the first olefin within the reactor and before introducing the first aluminum-containing compound into the reactor the process further comprises: introducing a C₄ to C₅ alkane into the reactor; and circulating the C₄ to C₅ alkane within the reactor to contact and remove at least a portion of any mineral oil at least partially coated on the anti-static agent.

A3. The process of A1 or A2, further comprising ensuring, prior to the introduction of the Ziegler-Natta catalyst particles into the reactor, the reactor comprises at least 500 ppmw of the second aluminum-containing compound based on a weight of the seedbed produced with the Ziegler-Natta catalyst in the reactor.

A4. The process of any of A1 to A3, wherein the process comprises ensuring, prior to the introduction of the Ziegler-Natta catalyst particles into the reactor, the reactor comprises at least 600 ppmw of the second aluminum containing compound based on the weight of the seedbed produced with the Ziegler-Natta catalyst in the reactor.

A5. The process of any of A1 to A4, wherein the process comprises ensuring, prior to the introduction of the Ziegler-Natta catalyst particles into the reactor, the reactor comprises 600 ppmw to 1,000 ppmw of the second aluminum containing compound based on the weight of the seedbed produced with the Ziegler-Natta catalyst in the reactor.

A6. The process of any of A1 to A5, wherein the first carrier gas, the second carrier gas, and the third carrier gas each comprise molecular nitrogen.

A7. The process of any of A1 to A6, wherein the first olefin and the second olefin independently comprise ethylene or ethylene and at least one C₃ to C₅ alpha-olefin.

A8. The process of any of A1 to A7, wherein the anti-static agent comprises a metal carboxylate, an ethoxylated amine, or a mixture thereof.

A9. The process of any of A1 to A8, wherein the first aluminum-containing compound and the second aluminum-containing compound independently comprise a compound represented by the formula AlR₍₃₋ₐ₎Xₐ, wherein R is a branched or straight chain alkyl, cycloalkyl, heterocycloalkyl, aryl, or a hydride radical having from 1 to 30 carbon atoms, X is a halogen, and a is 0, 1, or 2.

A10. The process of any of A1 to A9, wherein the first aluminum-containing compound and the second aluminum-containing compound independently comprise tri-hexyl-aluminum, triethylaluminum, trimethylaluminum, tri-isobutylaluminum, di-isobutylaluminum bromide, di-isobutylaluminum hydride, or a mixture thereof.

A11. The process of any of A1 to A10, further comprising introducing one or more pentanes, one or more butanes, ethane, methane, hydrogen, or a mixture thereof into the reactor with the first olefin, the anti-static agent, the first carrier gas, and the plurality of metallocene catalyst particles.

A12. The process of any of A1 to A11, wherein the kill agent comprises carbon monoxide, carbon dioxide, or a mixture thereof.

B1. A process for transitioning from a first Ziegler-Natta catalyst to a second Ziegler-Natta catalyst in gas phase polymerization reactor, comprising: introducing a first olefin, a first aluminum-containing compound, a first carrier gas, and a plurality of first Ziegler-Natta catalyst particles into the reactor under conditions effective to maintain the first Ziegler-Natta catalyst particles in a fluidized state and to polymerize the first olefin in the presence of the first Ziegler-Natta catalyst particles to produce a first polymer product; introducing a kill agent into the reactor to stop polymerization of the first olefin within the reactor; stopping introduction of the first Ziegler-Natta catalyst particles, the first aluminum-containing compound, and the first olefin into the reactor; removing a first portion of the first olefin from the reactor; removing the first polymer product and the first Ziegler-Natta catalyst particles from the reactor; reducing a concentration of the first olefin within the reactor to ≤1,000 ppmv; introducing water into the reactor after the concentration of the first olefin within the reactor is reduced to ≤1,000 ppmv, wherein the water reacts with at least a portion of any residual first aluminum-containing compound remaining within the reactor to produce a first reaction product comprising ethane (or another alkane, e.g., propane, butane, hexane) and a first alkylaluminum hydroxide; removing at least a portion of the ethane (or alkane) in the first reaction product from the reactor; introducing a seedbed produced with a second Ziegler-Natta catalyst into the reactor; introducing a second carrier gas into the reactor and venting the reactor to dry the seed bed to a water concentration of ≤20 ppmv; introducing a second aluminum-containing compound into the reactor, wherein the second aluminum-containing compound reacts with at least a portion of any residual water within the reactor to produce a second reaction product comprising ethane (or another alkane, e.g., propane, butane, hexane) and a second alkylaluminum hydroxide; removing at least a portion of the ethane (or alkane) in the second reaction product from the reactor; introducing a second olefin into the reactor; ensuring the reactor contains at least 500 ppmw of the second aluminum-containing compound based on a weight of the seedbed in the reactor; and introducing a plurality of second Ziegler-Natta catalyst particles, a third aluminum-containing compound, and a third carrier gas into the reactor containing the at least 500 ppmw of the second aluminum-containing compound under conditions effective to maintain the Ziegler-Natta catalyst particles in a fluidized state and to polymerize the second olefin in the presence of the second Ziegler-Natta catalyst particles to produce a second polymer product.

B2. The process of B1, wherein the process comprises ensuring, prior to the introduction of the second Ziegler-Natta catalyst particles into the reactor, the reactor comprises at least 600 ppmw of the second aluminum containing compound based on the weight of the seedbed produced with the second Ziegler-Natta catalyst in the reactor.

B3. The process of B1 or B2, wherein the process comprises ensuring, prior to the introduction of the second Ziegler-Natta catalyst particles into the reactor, the reactor comprises 600 ppmw to 1,000 ppmw of the second aluminum containing compound based on the weight of the seedbed produced with the second Ziegler-Natta catalyst in the reactor.

B4. The process of any of B1 to B3, wherein the first carrier gas, the second carrier gas, and the third carrier gas each comprise molecular nitrogen.

B5. The process of any of B1 to B4, wherein the first olefin and the second olefin independently comprise ethylene or ethylene and at least one C₃ to C₈ alpha-olefin.

B6. The process of any of B1 to B5, wherein the first aluminum-containing compound and the second aluminum-containing compound independently comprise a compound represented by the formula AlR₍₃₋ₐ₎Xₐ, wherein R is a branched or straight chain alkyl, cycloalkyl, heterocycloalkyl, aryl, or a hydride radical having from 1 to 30 carbon atoms, X is a halogen, and a is 0, 1, or 2.

B7. The process of any of B1 to B6, wherein the first aluminum-containing compound and the second aluminum-containing compound independently comprise tri-hexyl-aluminum, triethylaluminum, trimethylaluminum, tri-isobutylaluminum, di-isobutylaluminum bromide, di-isobutylaluminum hydride, or a mixture thereof.

B8. The process of any of B1 to B7, wherein the kill agent comprises carbon monoxide, carbon dioxide, or a mixture thereof.

Various terms have been defined above. To the extent a term used in a claim is not defined above, it should be given the broadest definition persons in the pertinent art have given that term as reflected in at least one printed publication or issued patent. Furthermore, all patents, test procedures, and other documents cited in this application are fully incorporated by reference to the extent such disclosure is not inconsistent with this application and for all jurisdictions in which such incorporation is permitted.

While the foregoing is directed to embodiments of the present invention, other and further embodiments of the invention may be devised without departing from the basic scope thereof, and the scope thereof is determined by the claims that follow.

What is claimed is:

1. A process for transitioning from a metallocene catalyst to a Ziegler-Natta catalyst in a gas phase polymerization reactor, comprising:
introducing a first olefin, an anti-static agent, a first carrier gas, and a plurality of metallocene catalyst particles into the reactor under conditions effective to maintain the metallocene catalyst particles in a fluidized state and to polymerize the first olefin in the presence of the metallocene catalyst particles to produce a first polymer product;
stopping introduction of the metallocene catalyst particles and the anti-static agent into the reactor;
introducing a kill agent into the reactor to stop polymerization of the first olefin within the reactor;
stopping introducing of the first olefin into the reactor;
removing a first portion of the first olefin from the reactor;
removing the first polymer product, the metallocene catalyst particles, and the anti-static agent from the reactor;
removing a second portion of the first olefin within the reactor such that the reactor contains ≤1,000 ppmv of the first olefin;
introducing a first aluminum-containing compound into the reactor after the concentration of the first olefin is reduced to ≤1,000 ppmv, wherein the first aluminum-containing compound reacts with at least a portion of any residual anti-static agent that remains within the reactor to produce a first reaction product comprising an alkane and at least one additional product;
removing at least a portion of the alkane in the first reaction product from the reactor;
introducing water into the reactor, wherein the water reacts with at least a portion of any residual first aluminum-containing compound remaining within the reactor to produce a second reaction product comprising an alkane and a first alkylaluminum hydroxide;
removing at least a portion of the alkane in the second reaction product from the reactor;
introducing a seedbed produced with a Ziegler-Natta catalyst into the reactor;
introducing a second carrier gas into the reactor and venting the reactor to dry the seed bed to a water concentration of ≤20 ppmv;
introducing a second aluminum-containing compound into the reactor, wherein the second aluminum-containing compound reacts with at least a portion of any residual water within the reactor to produce a third reaction product comprising an alkane and a second alkylaluminum hydroxide;
removing at least a portion of the alkane in the third reaction product from the reactor;
introducing a second olefin into the reactor; and
introducing a plurality of Ziegler-Natta catalyst particles and a third carrier gas into the reactor under conditions effective to maintain the Ziegler-Natta catalyst particles in a fluidized state and to polymerize the second olefin in the presence of the Ziegler-Natta catalyst particles to produce a second polymer product.

2. The process of claim 1, wherein the anti-static agent is introduced into the reactor in the form of a mixture comprising the anti-static agent and a mineral oil, wherein the mineral oil at least partially coats the anti-static agent, and wherein after removing the second portion of the first olefin within the reactor and before introducing the first aluminum-containing compound into the reactor the process further comprises:
introducing a C₄ to C₆ alkane into the reactor; and
circulating the C₄ to C₆ alkane within the reactor to contact and remove at least a portion of any mineral oil at least partially coated on the anti-static agent.

3. The process of claim 1, further comprising ensuring, prior to the introduction of the Ziegler-Natta catalyst particles into the reactor, the reactor comprises at least 500 ppmw of the second aluminum-containing compound based on a weight of the seedbed produced with the Ziegler-Natta catalyst in the reactor.

4. (canceled)

5. The process of claim 3, wherein the process comprises ensuring, prior to the introduction of the Ziegler-Natta catalyst particles into the reactor, the reactor comprises 600 ppmw to 1,000 ppmw of the second aluminum containing compound based on the weight of the seedbed produced with the Ziegler-Natta catalyst in the reactor.

6. The process of claim 1, wherein the first carrier gas, the second carrier gas, and the third carrier gas each comprise molecular nitrogen.

7. The process of claim 1, wherein the first olefin and the second olefin independently comprise ethylene or ethylene and at least one C₃ to C₈ alpha-olefin.

8. The process of claim 1, wherein the anti-static agent comprises a metal carboxylate, an ethoxylated amine, or a mixture thereof.

9. The process of claim 1, wherein the first aluminum-containing compound and the second aluminum-containing compound independently comprise a compound represented by the formula AlR₍₃₋ₐ₎Xₐ, wherein R is a branched or straight chain alkyl, cycloalkyl, heterocycloalkyl, aryl, or a hydride radical having from 1 to 30 carbon atoms, X is a halogen, and a is 0, 1, or 2.

10. The process of claim 9, wherein the first aluminum-containing compound and the second aluminum-containing compound independently comprise tri-hexyl-aluminum, triethylaluminum, trimethylaluminum, tri-isobutylaluminum, di-isobutylaluminum bromide, di-isobutylaluminum hydride, or a mixture thereof.

11. The process of claim 1, further comprising introducing one or more pentanes, one or more butanes, ethane, methane, hydrogen, or a mixture thereof into the reactor with the first olefin, the anti-static agent, the first carrier gas, and the plurality of metallocene catalyst particles.

12. The process of claim 1, wherein the anti-static agent is introduced with the metallocene catalyst particles as part of a catalyst composition.

13. The process of claim 1, wherein one or more of (i) the alkane of the first reaction product, (ii) the alkane of the second reaction product, and (iii) the alkane of the third reaction product is ethane.

14. A process for transitioning from a first Ziegler-Natta catalyst to a second Ziegler-Natta catalyst in gas phase polymerization reactor, comprising:
introducing a first olefin, a first aluminum-containing compound, a first carrier gas, and a plurality of first Ziegler-Natta catalyst particles into the reactor under conditions effective to maintain the first Ziegler-Natta catalyst particles in a fluidized state and to polymerize the first olefin in the presence of the first Ziegler-Natta catalyst particles to produce a first polymer product;
introducing a kill agent into the reactor to stop polymerization of the first olefin within the reactor;
stopping introduction of the first Ziegler-Natta catalyst particles, the first aluminum-containing compound, and the first olefin into the reactor;
removing a first portion of the first olefin from the reactor;
removing the first polymer product and the first Ziegler-Natta catalyst particles from the reactor;
reducing a concentration of the first olefin within the reactor to ≤1,000 ppmv;
introducing water into the reactor after the concentration of the first olefin within the reactor is reduced to ≤1,000 ppmv, wherein the water reacts with at least a portion of any residual first aluminum-containing compound remaining within the reactor to produce a first reaction product comprising an alkane and a first alkylaluminum hydroxide;
removing at least a portion of the alkane in the first reaction product from the reactor;
introducing a seedbed produced with a second Ziegler-Natta catalyst into the reactor;
introducing a second carrier gas into the reactor and venting the reactor to dry the seed bed to a water concentration of ≤20 ppmv;
introducing a second aluminum-containing compound into the reactor, wherein the second aluminum-containing compound reacts with at least a portion of any residual water within the reactor to produce a second reaction product comprising an alkane and a second alkylaluminum hydroxide;
removing at least a portion of the alkane in the second reaction product from the reactor;
introducing a second olefin into the reactor;
ensuring the reactor contains at least 500 ppmw of the second aluminum-containing compound based on a weight of the seedbed in the reactor; and
introducing a plurality of second Ziegler-Natta catalyst particles, a third aluminum-containing compound, and a third carrier gas into the reactor containing the at least 500 ppmw of the second aluminum-containing compound under conditions effective to maintain the Ziegler-Natta catalyst particles in a fluidized state and to polymerize the second olefin in the presence of the second Ziegler-Natta catalyst particles to produce a second polymer product.

15. The process of claim 14, wherein one or more of (i) the alkane of the first reaction product, (ii) the alkane of the second reaction product, and (iii) the alkane of the third reaction product is ethane.

16. The process of claim 14, wherein the process comprises ensuring, prior to the introduction of the second Ziegler-Natta catalyst particles into the reactor, the reactor comprises at least 600 ppmw of the second aluminum containing compound based on the weight of the seedbed produced with the second Ziegler-Natta catalyst in the reactor.

17. (canceled)

18. The process of claim 14, wherein the first carrier gas, the second carrier gas, and the third carrier gas each comprise molecular nitrogen.

19. The process of claim 14, wherein the first olefin and the second olefin independently comprise ethylene or ethylene and at least one C₃ to C₈ alpha-olefin.

20. The process of claim 14, wherein the first aluminum-containing compound and the second aluminum-containing compound independently comprise a compound represented by the formula AlR₍₃₋ₐ₎Xₐ, wherein R is a branched or straight chain alkyl, cycloalkyl, heterocycloalkyl, aryl, or a hydride radical having from 1 to 30 carbon atoms, X is a halogen, and a is 0, 1, or 2.

21. The process of claim 14, wherein the first aluminum-containing compound and the second aluminum-containing compound independently comprise tri-hexyl-aluminum, triethylaluminum, trimethylaluminum, tri-isobutylaluminum, di-isobutylaluminum bromide, di-isobutylaluminum hydride, or a mixture thereof.

22. The process of claim 14, wherein the kill agent comprises carbon monoxide, carbon dioxide, or a mixture thereof.
